(19) United States
(12) Patent Application Publication
(10) Pub. No.: US 2025/0379683 A1
(43) Pub. Date: Dec. 11, 2025

(54) TECHNIQUES FOR INDICATING A CONTROL CHANNEL ELEMENT PUNCTURING PATTERN

(71) Applicant: QUALCOMM Incorporated, San Diego, CA (US)

(72) Inventors: Javier RODRIGUEZ FERNANDEZ, San Diego, CA (US); Kazuki TAKEDA, Minato-ku (JP); Kianoush HOSSEINI, San Diego, CA (US); Alberto RICO ALVARINO, San Diego, CA (US)

(21) Appl. No.: 18/737,004

(22) Filed: Jun. 7, 2024

(51) Int. Cl. H04L 1/00; H04W 72/231; H04W 72/51

(52) U.S. Cl. CPC H04L 1/0068; H04W 72/231; H04W 72/51

(57) ABSTRACT

Methods, systems, and devices for wireless communications are described. A user equipment (UE) may decode downlink control channel candidates according to a puncturing pattern indicated by a network entity. For example, the UE may receive control signaling including information that indicates that each control channel element (CCE) of a subset of CCEs within a control resource set (CORESET) is to be punctured. The network entity may output a downlink control channel message based on puncturing each CCE of the subset of CCEs within the CORESET. The UE may process, based on the information that indicates that each CCE of the subset is to be punctured, a set of downlink control channel candidates within the CORESET. The UE may decode the downlink control channel message based on processing the set of downlink control channel candidates.

### FIELD OF TECHNOLOGY

The following relates to wireless communications, including techniques for indicating a control channel element (CCE) puncturing pattern.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, wireless communication devices, such as UEs or network entities, puncture scheduled, allocated, or configured communication resources such as to make the resources available for other communications.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling including information that indicates that each control channel element (CCE) of a subset of CCEs within a control resource set (CORESET) is to be punctured, processing, based least in part on the information that indicates that each CCE of the subset is to be punctured, a set of downlink control channel candidates within the CORESET, and decoding a downlink control channel message based on processing the set of downlink control channel candidates.

A UE for wireless communications is described. The UE may include one or more memories storing processor executable code, and one or more processors coupled with the one or more memories. The one or more processors may individually or collectively be operable to execute the code to cause the UE to receive control signaling including information that indicates that each CCE of a subset of CCEs within a CORESET is to be punctured, process, based least in part on the information that indicates that each CCE of the subset is to be punctured, a set of downlink control channel candidates within the CORESET, and decode a downlink control channel message based on processing the set of downlink control channel candidates.

Another UE for wireless communications is described. The UE may include means for receiving control signaling including information that indicates that each CCE of a subset of CCEs within a CORESET is to be punctured, means for processing, based least in part on the information that indicates that each CCE of the subset is to be punctured, a set of downlink control channel candidates within the CORESET, and means for decoding a downlink control channel message based on processing the set of downlink control channel candidates.

A non-transitory computer-readable medium storing code for wireless communications is described. The code may include instructions executable by one or more processors to receive control signaling including information that indicates that each CCE of a subset of CCEs within a CORESET is to be punctured, process, based least in part on the information that indicates that each CCE of the subset is to be punctured, a set of downlink control channel candidates within the CORESET, and decode a downlink control channel message based on processing the set of downlink control channel candidates.

In some examples of the method, UEs, and non-transitory computer-readable medium described herein, receiving the control signaling may include operations, features, means, or instructions for receiving one or more radio resource control (RRC) messages including the information that indicates that each CCE of the subset of CCEs is to be punctured.

In some examples of the method, UEs, and non-transitory computer-readable medium described herein, receiving the control signaling may include operations, features, means, or instructions for receiving a medium access control (MAC)-control element (CE) activation command, where the MAC-CE activation command activates a state that indicates that each CCE of the subset of CCEs is to be punctured.

In some examples of the method, UEs, and non-transitory computer-readable medium described herein, receiving the control signaling may include operations, features, means, or instructions for receiving one or more downlink control information (DCI) messages including one or more DCI fields, where the one or more DCI fields include the information that indicates that each CCE of the subset of CCEs is to be punctured.

In some examples of the method, UEs, and non-transitory computer-readable medium described herein, the one or more DCI messages may be associated with a DCI format and the DCI format includes the one or more DCI fields including a set of indexes indicative of the subset of CCEs to be punctured, one or more first indications of respective positions of first control channel elements of the subset of control channel elements and respective quantities of contiguous control channel elements punctured, one or more second indications of respective entries in a table, or any combination thereof.

In some examples of the method, UEs, and non-transitory computer-readable medium described herein, receiving the control signaling may include operations, features, means, or instructions for receiving a first DCI message including an identifier of the CORESET and the information that indicates that each CCE of the subset of CCEs within the CORESET is to be punctured, and where decoding the downlink control channel message includes and receiving a second DCI message including a downlink grant or uplink grant for communications associated with the UE.

In some examples of the method, UEs, and non-transitory computer-readable medium described herein, receiving the control signaling may include operations, features, means, or instructions for receiving two or more transmissions of the first DCI message, where the two or more transmissions may be associated with respective log-likelihood ratios (LLRs) and decoding the first DCI message based on a combination of the respective LLRs associated with the two or more transmissions.

Some examples of the method, UEs, and non-transitory computer-readable medium described herein may further include operations, features, means, or instructions for transmitting a feedback message based on failing to decode the first DCI message before an expiration of a timer at the UE and receiving a retransmission of the first DCI message based on transmitting the feedback message.

In some examples of the method, UEs, and non-transitory computer-readable medium described herein, receiving the control signaling may include operations, features, means, or instructions for receiving a group-common or UE-specific downlink control message including a preemption indication, where the preemption indication includes the information that indicates that each CCE of the subset of CCEs is to be punctured.

In some examples of the method, UEs, and non-transitory computer-readable medium described herein, receiving the control signaling may include operations, features, means, or instructions for receiving the information that indicates that a group of CCEs of a set of multiple groups of CCEs within the CORESET is to be punctured, where the group includes the subset of CCEs within the CORESET.

In some examples of the method, UEs, and non-transitory computer-readable medium described herein, processing the set of downlink control channel candidates may include operations, features, means, or instructions for processing each CCE of a first downlink control channel candidate, where one or more of the processed CCEs of the first downlink control channel candidate may be punctured in accordance with the information received via the control signaling.

In some examples of the method, UEs, and non-transitory computer-readable medium described herein, processing the one or more CCEs that may be punctured within the first downlink control channel candidate may include operations, features, means, or instructions for muting the one or more control channel candidates that may be punctured within the first downlink control channel candidate.

In some examples of the method, UEs, and non-transitory computer-readable medium described herein, processing the set of downlink control channel candidates may include operations, features, means, or instructions for processing a subset of CCEs of a first downlink control channel candidate, where the subset excludes one or more CCEs of the first downlink control channel candidate that may be punctured in accordance with the information received via the control signaling.

Some examples of the method, UEs, and non-transitory computer-readable medium described herein may further include operations, features, means, or instructions for transmitting a capability message associated with puncturing of CCEs, where receiving the control signaling including the information that indicates that each CCE of the subset of CCEs within the CORESET is to be punctured may be based on the capability message.

In some examples of the method, UEs, and non-transitory computer-readable medium described herein, the capability message includes an indication that the UE supports rate-matching over aggregation levels associated with different powers of two or that the UE supports rate-matching over aggregation levels different from the aggregation levels associated with different powers of two.

Some examples of the method, UEs, and non-transitory computer-readable medium described herein may further include operations, features, means, or instructions for performing a set of control channel estimates using CCEs within the CORESET based on the information that indicates that each CCE of the subset of CCEs is to be punctured.

Some examples of the method, UEs, and non-transitory computer-readable medium described herein may further include operations, features, means, or instructions for counting a quantity of blind decodes based on the information that indicates that each CCE of the subset of CCEs is to be punctured.

In some examples of the method, UEs, and non-transitory computer-readable medium described herein, the subset of CCEs of the CORESET includes one or more contiguous CCEs of the control resource set, one or more non-contiguous CCEs in the CORESET, or both the one or more contiguous CCEs and the one or more non-contiguous CCEs.

A method for wireless communications by a network entity is described. The method may include outputting control signaling including information that indicates that each CCE of a subset of CCEs within a CORESET is to be punctured and outputting, via the CORESET, a downlink control channel message based on puncturing each CCE of the subset of CCEs within the CORESET.

A network entity for wireless communications is described. The network entity may include one or more memories storing processor executable code, and one or more processors coupled with the one or more memories. The one or more processors may individually or collectively be operable to execute the code to cause the network entity to output control signaling including information that indicates that each CCE of a subset of CCEs within a CORESET is to be punctured and output, via the CORESET, a downlink control channel message based on puncturing each CCE of the subset of CCEs within the CORESET.

Another network entity for wireless communications is described. The network entity may include means for outputting control signaling including information that indicates that each CCE of a subset of CCEs within a CORESET is to be punctured and means for outputting, via the CORESET, a downlink control channel message based on puncturing each CCE of the subset of CCEs within the CORESET.

A non-transitory computer-readable medium storing code for wireless communications is described. The code may include instructions executable by one or more processors to output control signaling including information that indicates that each CCE of a subset of CCEs within a CORESET is to be punctured and output, via the CORESET, a downlink control channel message based on puncturing each CCE of the subset of CCEs within the CORESET.

In some examples of the method, network entities, and non-transitory computer-readable medium described herein, outputting the control signaling may include operations, features, means, or instructions for outputting one or more RRC messages including the information that indicates that each CCE of the subset of CCEs is to be punctured.

In some examples of the method, network entities, and non-transitory computer-readable medium described herein, outputting the control signaling may include operations, features, means, or instructions for outputting a MAC-CE activation command, where the MAC-CE activation command activates a state that indicates that each CCE of the subset of CCEs is to be punctured.

In some examples of the method, network entities, and non-transitory computer-readable medium described herein, outputting the control signaling may include operations, features, means, or instructions for outputting one or more DCI messages including one or more DCI fields, where the one or more DCI fields include the information that indicates that each CCE of the subset of CCEs is to be punctured.

In some examples of the method, network entities, and non-transitory computer-readable medium described herein, the one or more DCI messages may be associated with a DCI format and the DCI format includes the one or more DCI fields including a set of indexes indicative of the subset of CCEs to be punctured, one or more first indications of respective positions of first control channel elements of the subset of control channel elements and respective quantities of contiguous control channel elements punctured, one or more second indications of respective entries in a table, or any combination thereof.

In some examples of the method, network entities, and non-transitory computer-readable medium described herein, outputting the control signaling may include operations, features, means, or instructions for outputting a first DCI message including an identifier of the CORESET and the information that indicates that each CCE of the subset of CCEs within the CORESET is to be punctured, and where outputting the downlink control channel message includes and outputting a second DCI message including a downlink grant associated with a UE or a group of UEs, where a downlink control channel carrying the second DCI message may be punctured in accordance with the information of the first DCI message.

In some examples of the method, network entities, and non-transitory computer-readable medium described herein, outputting the control signaling may include operations, features, means, or instructions for outputting two or more transmissions of the first DCI message, where the two or more transmissions may be associated with respective LLRs.

Some examples of the method, network entities, and non-transitory computer-readable medium described herein may further include operations, features, means, or instructions for obtaining a feedback message and outputting a retransmission of the first DCI message based on obtaining the feedback message.

In some examples of the method, network entities, and non-transitory computer-readable medium described herein, outputting the control signaling may include operations, features, means, or instructions for outputting a group-common or UE-specific downlink control message including a preemption indication, where the preemption indication includes the information that indicates that each CCE of the subset of CCEs is to be punctured.

In some examples of the method, network entities, and non-transitory computer-readable medium described herein, outputting the control signaling may include operations, features, means, or instructions for outputting the information that indicates that a group of CCEs of a set of multiple groups of CCEs within the CORESET is to be punctured, where the group includes the subset of CCEs within the CORESET.

In some examples of the method, network entities, and non-transitory computer-readable medium described herein, rate matching each CCE of a first downlink control channel candidate, where one or more of the rate matched CCEs of the first downlink control channel candidate may be punctured in accordance with the information output via the control signaling, and where outputting the downlink control channel message may be based on the rate matching.

In some examples of the method, network entities, and non-transitory computer-readable medium described herein, rate matching a subset of CCEs of a first downlink control channel candidate, where the subset excludes one or more CCEs of the first downlink control channel candidate that may be punctured in accordance with the information output via the control signaling, and where outputting the downlink control channel message may be based on the rate matching.

Some examples of the method, network entities, and non-transitory computer-readable medium described herein may further include operations, features, means, or instructions for obtaining a capability message associated with puncturing of CCEs, where outputting the control signaling including the information that indicates that each CCE of the subset of CCEs within the CORESET is to be punctured may be based on the capability message.

In some examples of the method, network entities, and non-transitory computer-readable medium described herein, the capability message includes an indication that a UE supports rate-matching over aggregation levels associated with different powers of two or that the UE supports rate-matching over aggregation levels different from the aggregation levels associated with different powers of two.

In some examples of the method, network entities, and non-transitory computer-readable medium described herein, the subset of CCEs of the CORESET includes one or more contiguous CCEs of the control resource set, one or more non-contiguous CCEs in the CORESET, or both the one or more contiguous CCEs and the one or more non-contiguous CCEs.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support techniques for indicating a control channel element (CCE) puncturing pattern in accordance with one or more aspects of the present disclosure.

FIGS. 3A and 3B show examples of control resource sets (CORESETs) that support techniques for indicating a CCE puncturing pattern in accordance with one or more aspects of the present disclosure.

FIG. 4 shows an example of a process flow that supports techniques for indicating a CCE puncturing pattern in accordance with one or more aspects of the present disclosure.

FIGS. 5 and 6 show block diagrams of devices that support techniques for indicating a CCE puncturing pattern in accordance with one or more aspects of the present disclosure.

FIG. 7 shows a block diagram of a communications manager that supports techniques for indicating a CCE puncturing pattern in accordance with one or more aspects of the present disclosure.

FIG. 8 shows a diagram of a system including a device that supports techniques for indicating a CCE puncturing pattern in accordance with one or more aspects of the present disclosure.

FIGS. 9 and 10 show block diagrams of devices that support techniques for indicating a CCE puncturing pattern in accordance with one or more aspects of the present disclosure.

FIG. 11 shows a block diagram of a communications manager that supports techniques for indicating a CCE puncturing pattern in accordance with one or more aspects of the present disclosure.

FIG. 12 shows a diagram of a system including a device that supports techniques for indicating a CCE puncturing pattern in accordance with one or more aspects of the present disclosure.

FIGS. 13 through 16 show flowcharts illustrating methods that support techniques for indicating a CCE puncturing pattern in accordance with one or more aspects of the present disclosure.

### DETAILED DESCRIPTION

Some wireless communication devices may implement resource puncturing, such as physical downlink control channel (PDCCH) puncturing, in order to improve utilization of communication resources. For example, a network entity may puncture one or more control channel elements (CCEs) of an aggregation level (AL) assigned to a first UE such that the one or more CCEs may be used for a second UE to blindly decode a PDCCH candidate. Puncturing the one or more CCEs may reduce a blockage probability and improve a control resource set (CORESET) mapping efficiency by using resources of the PDCCH for an additional UE (i.e., enabling another UE to successfully decode a PDCCH candidate). The network entity may puncture the one or more CCEs according to different puncturing patterns, such as contiguous or non-contiguous puncturing patterns. However, the UE that is subject to puncturing (e.g., is configured to perform blind decoding on punctured CCEs) may perform a higher quantity of blind decoding attempts for one or more CCEs punctured for an AL of the UE (e.g., CCEs including information for another UE). That is, the UE may be required to attempt multiple puncturing hypothesis to decode the control message (e.g., downlink control information (DCI)), which may result in increased UE complexity.

Various aspects described herein relate generally to PDCCH puncturing. Some aspects more specifically relate to control signaling indicating a PDCCH puncturing pattern. In some examples, a network entity may transmit control signaling indicating the puncturing pattern to one or more user equipments (UEs). For example, a UE may receive the control signaling indicating the puncturing pattern and process a set of control channel elements (CCEs) for one or more PDCCH candidates based on the puncturing pattern. In some examples, the network entity may transmit the indication of the puncturing pattern via a radio resource control (RRC) message, a medium access control (MAC)-control element (CE) command, or a DCI message. Additionally, or alternatively, the network entity may transmit multiple control messages, such as multiple DCI messages. The network entity may utilize various techniques to indicate the puncturing pattern, such as via by signaling different granularity levels (e.g., indicating groups of CCEs that are punctured), signaling indexes of punctured CCEs, group common signaling, or periodic or repeated puncturing signaling.

Particular aspects of the subject matter described in this disclosure can be implemented to realize one or more of the following potential advantages. In some examples, by indicating the puncturing pattern via control signaling, the described techniques can be used to reduce power consumption and complexity at the UE. For example, power consumption and complexity associated with blind decoding of PDCCH candidates by UE may be reduced by signaling an indication of a puncturing pattern. That is, the UE may avoid or limit attempting to decode PDCCH candidates in one or more CCEs indicated as being punctured via the puncturing pattern. Additionally, by puncturing the one or more CCEs, the network entity may reduce a blockage probability and improve a control resource set (CORESET) mapping efficiency by using resources of the PDCCH for an additional UE. In other words, puncturing the one or more CCEs may enable another UE to successfully decode a PDCCH candidate. Accordingly, the techniques described herein support improved utilization of communication resources and reduced computing overhead associated with decoding control information.

Aspects of the disclosure are initially described in the context of wireless communications systems. Aspects of the disclosure are also illustrated and described in the context of example CORESETs and a process flow. Aspects of the disclosure are further illustrated by and described with reference to apparatus diagrams, system diagrams, and flowcharts that relate to techniques for indicating a CCE puncturing pattern.

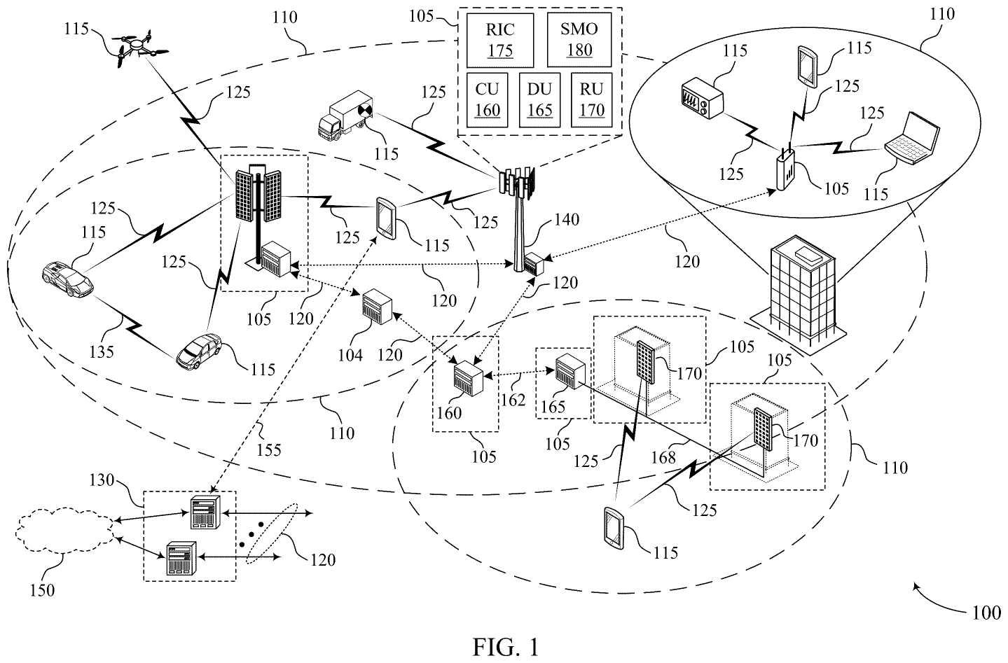

FIG. 1 shows an example of a wireless communications system 100 that supports techniques for indicating a CCE puncturing pattern in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level (AL) for a control channel candidate may refer to an amount of control channel resources (e.g., CCEs) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Wireless communication devices (e.g., UEs 115 and network entities 105) of the wireless communications system 200 may implement resource puncturing, such as physical downlink control channel (PDCCH) puncturing, in order to improve utilization of communication resources. Puncturing the one or more CCEs may reduce a blockage probability and improve CORESET mapping efficiency by using resources of the PDCCH for an additional UE 115 (i.e., enabling another UE 115 to successfully decode a PDCCH candidate). The network entity 105 may puncture the one or more CCEs according to different puncturing patterns, such as contiguous or non-contiguous puncturing patterns. However, the UE 115 that is subject to puncturing (e.g., is configured to perform blind decoding on punctured CCEs) may perform a higher quantity of blind decoding attempts for one or more CCEs punctured for an AL of the UE (e.g., CCEs including information for another UE). That is, the UE 115 may be required to attempt multiple puncturing hypothesis to decode the control message, which may result in increased UE complexity.

The UEs 115 may improve a performance level by receiving an indication of a puncturing pattern to be used by the network entity 105. For example, a UE 115 may receive control signaling including information that indicates that each CCE of a subset of CCEs within a CORESET is to be punctured. In other words, the UE 115 may receive control signaling including information that indicates a puncturing pattern for a CORESET. Based on the information in the control signaling, the UE 115 may process a set of downlink control channel candidates (e.g., PDCCH candidates) within the CORESET and decode a downlink control channel message (e.g., a PDCCH message) based on the processing. By processing the set of downlink control channel candidates based on the puncturing pattern, the UE 115 may reduce a quantity of blind decodes, which may reduce power consumption and improve performance at the UE 115. In other words, the UE 115 may avoid blind decodes on one or more downlink control channel candidates based on the puncturing pattern, which may reduce power consumption at the UE 115.

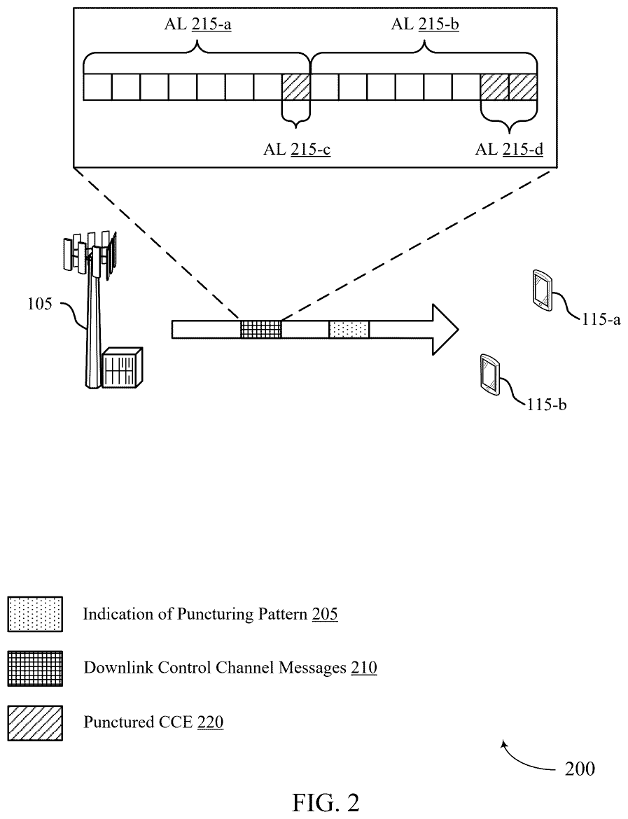

FIG. 2 shows an example of a wireless communications system 200 that supports techniques for indicating a CCE puncturing pattern in accordance with one or more aspects of the present disclosure. The wireless communications system 200 may implement or be implemented by various aspects of the wireless communications system 100. For example, the wireless communications system 200 may include a network entity 105, a UE 115-a, and a UE 115-b, which may be examples of the network entity 105 and the UE 115 as described with reference to FIG. 1.

The wireless communications system 200 may support PDCCH puncturing. That is, the network entity 105 may perform PDCCH puncturing to increase a CORESET occupancy and reduce a blockage probability. For example, the network entity 105 may transmit PDCCHs to UEs, such as the UE 115-a and the UE 115-b, with variable quantities of resources (e.g., different ALs associated with one or more CCEs). As an example, the network entity 105 may transmit a PDCCH with a high AL to the UE 115-a having a relatively poor link quality and a PDCCH with a lower AL to the UE 115-b having relatively high link quality. In other words, the network entity 105 may transmit PDCCH with a quantity of resources based on a link quality of a UE. However, in examples in which the network entity 105 transmits PDCCH to multiple UEs with poor link quality, a quantity of available CCEs may be limited. For example, transmitting a PDCCH to multiple UEs with relatively high ALs may introduce blockage.

To reduce a blockage probability, the network entity 105 may perform PDCCH puncturing for one or more UEs 115. That is, the network entity 105 may puncture one or more CCEs of an AL (e.g., CCE-level puncturing), where the one or more punctured CCEs may be used for another UE. As an example, the network entity 105 may assign an AL 215-a including a quantity of CCEs to the UE 115-a. ALs may support a corresponding quantity of CCEs. In the example of FIG. 2, the AL 215-a (e.g., AL8) may include 8 CCEs. However, the UE 115-a assigned to the AL 215-a may decode the PDCCH message using a quantity of CCEs lower than the quantity of CCEs in the AL 215-a. Accordingly, the network entity 105 may puncture a CCE of the AL 215-a and assign an AL 215-c including the punctured CCE 220 to another UE, such as the UE 115-b. Similarly, the network entity 105 may assign an AL 215-b including a quantity of CCEs to the UE 115-b. The UE 115-b may decode the PDCCH message using a quantity of CCEs lower than the quantity of CCEs in the AL 215-b, and the network entity 105 may puncture two CCEs of the AL 215-b and assign an AL 215-d including the punctured CCEs 220 to another UE, such as the UE 115-a.

In some cases, the network entity 105 may puncture CCEs according to a puncturing pattern. For example, the network entity 105 may puncture contiguous or non-contiguous CCEs, such as according to contiguous puncturing patterns or non-contiguous puncturing patterns. As illustrated in FIG. 2, the network entity 105 punctures the last two CCEs of the AL 215-b, where the punctured CCEs 220 are contiguous. As described herein, the puncturing pattern may refer to a subset of CCEs, in a CORESET that includes a plurality of CCEs, to be punctured. For example, the puncturing pattern may refer to a subset of CCEs including contiguous CCEs, non-contiguous CCEs, or both. In other words, the subset of CCEs may include one or more first CCEs which are contiguous, one or more second CCEs which are non-contiguous, or both. In some cases, the subset refers to multiple different groups of CCEs, and each group may be contiguous and/or non-contiguous.

In some cases, the network entity 105 may perform CCE to PDCCH candidate mapping via a hashing function. For example, the UE 115-a, the UE 115-b or both may use the hashing function to identify where PDCCH candidates for a CORESET may be located within the CORESET (e.g., reducing complexity at the UE), and the network entity 105 may use the hashing function to map the CCEs to PDCCH candidates. The hashing function may include or be based on an AL of the PDCCH candidate, a candidate index, a quantity of CCEs in the CORESET, a threshold quantity of candidates that the UE is to monitor, or the like. The UE may identify, via the hashing function, one or more locations to monitor for a PDCCH candidate. Accordingly, the network entity 105 may map PDCCH candidates for the UE to the one or more locations. The network entity 105 may improve a mapping efficiency by puncturing one or more CCEs in the CORESET. For example, resource utilization efficiency is reduced in cases in which a UE assigned to an AL does not use all the CCEs in the AL. By puncturing one or more CCEs in the AL and using the punctured CCEs for another UE, the network entity 105 may reduce a quantity of unused CCEs. Additionally, because the hashing function produces a relatively small quantity of locations within the CORESET for the network entity to map PDCCH candidates for a UE to, there may be reduced space in the CORESET to map PDCCH candidates without incurring a blockage. However, puncturing one or more CCEs may reduce a blockage probability by freeing the one or more CCEs for other PDCCH candidates.

In cases in which the network entity 105 punctures a relatively large quantity of CCEs in a large AL (e.g., AL8 or larger) or any CCEs in a small AL (e.g., AL4 or smaller), the UE 115-a or the UE 115-b may perform multiple puncturing hypotheses to decode a DCI in the PDCCH. That is, a quantity of blind decoding attempts at the UE 115-a or the UE 115-b may increase in examples in which the network entity 105 punctures the relatively large quantity of CCES for the large AL or any CCEs in the small AL. Accordingly, the wireless communications system 200 described herein may support transmission of an indication of the puncturing pattern 205 by the network entity 105 to one or more UEs, including the UE 115-a, the UE 115-b, or both.

The network entity 105 may transmit the indication of the puncturing pattern 205 to the UE 115-a, the UE 115-b, or both based on a type of puncturing pattern or a capability of the UE 115-a, the UE 115-b, or both. The puncturing pattern may be signaled via various types of control messages. For example, the network entity 105 signals the indication of the puncturing pattern 205 via a RRC message. RRC signaling or messaging may be used in examples in which the network entity 105 identifies one or more CCEs to be punctured before a threshold duration of the one or more CCEs. That is, because RRC signaling may be more complex and less periodic than other types of control signaling, RRC signaling may be used to signal the puncturing pattern when the network entity 105 identifies CCEs to be punctured prior to a threshold duration of time before the CCEs (e.g., the network entity 105 has enough time to generate and transmit the RRC signaling and the UE 115 has enough time to process the RRC signaling before the punctured CCEs).

Additionally, or alternatively, the network entity 105 may transmit the indication of the puncturing pattern 205 via a MAC-CE activation command. For example, the UE 115-a, the UE 115-b, or both may be configured with (e.g., include, have, etc.) multiple different states (e.g., transmission configuration indication (TCI) states) corresponding to different puncturing patterns. For example, a first state may correspond to a first puncturing pattern including a first quantity of punctured CCEs, a second state may correspond to a second puncturing pattern including a second quantity of punctured CCEs, and so on. The network entity 105 may output the MAC-CE activation command activating one of the multiple states at the UE 115-a, the UE 115-b, or both, where the state corresponds to a puncturing pattern. The various states may be signaled or configured using control signaling, such as RRC. For example, a first RRC message configures the first and second states, and the MAC-CE activates one of the states.

In some examples, the network entity 105 may transmit the indication of the puncturing pattern 205 via a DCI message. For example, the network entity 105 may transmit the indication of the puncturing pattern 205 via the DCI in examples in which the network entity 105 identifies the CCEs to be punctured after the threshold duration of time prior to the CCEs. In other words, if the network entity 105 identifies the CCEs to be punctured shortly before (e.g., outside of the threshold duration) the CCEs, the network entity 105 may transmit the indication of the puncturing pattern 205 via the DCI. In such examples, the network entity 105 may transmit the indication of the puncturing pattern 205 via one or more DCI fields. For example, the network entity 105 may encode the indication of the puncturing pattern 205 in the one or more DCI fields of the DCI message.

In examples in which the network entity 105 is to transmit unicast data to a single UE, such as the UE 115-a, the network entity 105 may transmit the DCI including the indication of the puncturing pattern 205 according to a DCI format. For example, the DCI format (e.g., DCI 0_X or DCI 1_X) may include indexes of CCEs to be punctured by the network entity 105 in a CORESET, a set of encoded values indicating a position of a first punctured CCE and/or a quantity of contiguous CCEs punctured (e.g., identifying locations of the punctured CCEs), an indication of an entry in a predefined table, or any combination thereof. In some examples, the DCI format may include different information based on whether the puncturing pattern is contiguous or non-contiguous. For example, the DCI format may include multiple positions of first punctured CCEs and quantities of contiguous CCEs punctured. By way of example, the DCI format may include a first position corresponding to a first quantity of CCEs, a second position corresponding to a second quantity of CCEs, and so on. In other words, the DCI format may indicate multiple non-contiguous groups of CCEs (where CCEs within a group are contiguous) or one contiguous group of CCEs. Additionally, or alternatively, the DCI format may include multiple entries in the predefined table. For example, a first entry may correspond to a first group of punctured CCEs, a second entry may correspond to a second group of CCEs, and so on.

Alternatively, in examples in which the network entity 105 is to transmit multicast data to a group of UEs, such as the UE 115-a and the UE 115-b, the network entity 105 may transmit a PDCCH including a preemption indication. For example, the PDCCH including the preemption indication may indicate a set of punctured CCEs in a CORESET associated with a CORESET identifier (e.g., CORESET Id). That is, the network entity 105 may transmit the indication of the puncturing pattern 205 via the preemption indication, which indicates the set of punctured CCEs in the CORESET, where the CORESET is identified according to a CORESET identifier. In some cases, the DCI message that contains the preemption indication and the indication of the puncturing pattern may be a UE specific DCI message. That is, the downlink control message containing a preemption indication may be group-common or UE-specific, depending on whether the puncturing pattern applies to every UE monitoring PDCCH candidates in the CORESET or the puncturing pattern applies to a single UE

In examples in which the network entity 105 transmits the indication of the puncturing pattern 205 via a DCI message, the DCI message may be separate from a DCI message included in one or more PDCCH candidates to which the indication of the puncturing pattern 205 is relevant. For example, the network entity 105 may transmit a first DCI message including the indication of the puncturing pattern 205 for a CORESET and, separately, downlink control channel messages 210 including a second DCI message via the CORESET. The first DCI message may be associated with a DCI format (e.g., DCI 2_x) in which a preemption indication is included. In examples in which the indication of the puncturing pattern 205 is applicable for a UE of a group of UEs, the first DCI may be configured within a UE-specific search space or a common search space (e.g., for a common CORESET including punctured PDCCH candidates). The first DCI message may include the indication of the puncturing pattern 205 and an identifier of the CORESET (e.g., a CORESET Id). In examples in which the first DCI is transmitted to a single UE, the first DCI message may be scrambled via a radio network temporary identifier (RNTI) (e.g., a common network entity-dependent RNTI) or a cell identifier. In examples in which the first DCI is transmitted to multiple UEs, the first DCI message may be scrambled via a modulation and coding scheme (MCS)-RNTI, a cell-RNTI (C-RNTI), a configured scheduling-RNTI, or the like. Additionally, or alternatively, the second DCI message may include an uplink grant or a downlink grant for the UE 115-a, the UE 115-b, or both.

In some cases, the network entity 105 may output periodic or repeated transmissions of the first DCI message, retransmit the first DCI message based on feedback from the UE 115-a or the UE 115-b, or both. For example, the network entity 105 may output periodic or repeated transmissions of the first DCI message to increase a probability of successful decoding of the first DCI message at the UE 115-a, the UE 115-b, or both. In such cases, a first transmission of the first DCI message may not be received correctly by a UE having a relatively low signal-to-interference noise ratio (SINR). However, the network entity 105 may increase a probability of successful decoding of the first DCI message based on outputting repetitions of the first DCI message. In examples in which the network entity 105 outputs the periodic or repeated transmissions of the first DCI message, a receiving UE, such as the UE 115-a or the UE 115-b, may perform log-likelihood ratio (LLR) combining. For example, each transmission of the first DCI message may be associated with a LLR, and the UE may perform LLR combining to decode the first DCI message. In other words, the UE may combine a first LLR of a first transmission of the first DCI message with a second LLR of a second transmission of the first DCI message, and so on.

Additionally, or alternatively, the network entity 105 may retransmit the DCI carrying the puncturing pattern indication based on feedback from the UE 115-a, the UE 115-b, or both. For example, the UE 115-a may attempt to decode the first DCI message and, based on failing to decode the first DCI message (e.g., before an expiration of a timer), transmit a feedback message to the network entity 105. In other words, the UE 115-a may implement a timer associated with decoding the first DCI message, where expiration of the timer triggers the UE 115-a to transmit feedback (e.g., HARQ feedback) to the network entity 105. The network entity 105, based on receiving the feedback, may retransmit the first DCI message to the UE 115-a. In some examples, the UE 115-a may perform LLR combining based on receiving the retransmission of the first DCI message. Alternatively, the network entity 105 may refrain from puncturing the one or more CCEs based on receiving the feedback from the UE 115-a. For example, if the network entity 105 receives a negative acknowledgement (NACK) for the first DCI message, then the network entity 105 does not implement the puncturing pattern for later decoding of the second DCI.

The network entity 105 may output the downlink control channel message 210 in accordance with the puncturing pattern. For example, the network entity 105 may puncture the one or more CCEs according to the puncturing pattern and output the downlink control channel message 210 via the CORESET having the one or more punctured CCEs (e.g., encode the downlink control channel message via the non-punctured CCEs). In examples in which the indication of the puncturing pattern 205 is sent via the first DCI, the network entity 105 may output the second DCI via the CORESET having the one or more punctured CCEs. That is, the downlink control channel message 210 may include the second DCI.

In some examples, a quantity of PDCCH candidates to be monitored by the UE 115-a, the UE 115-b, or both may be based on an AL, whether rate matching is performed by the network entity 105 over ALs having non-negative powers of two or over non-punctured CCEs, a puncturing level for each AL, or any combination thereof.

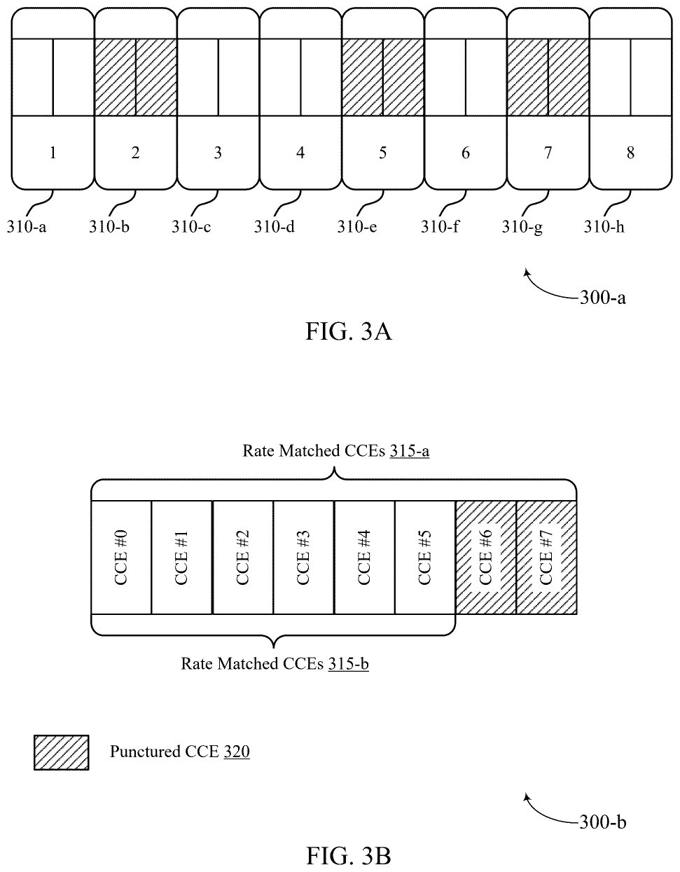

The UE 115-a, the UE 115-b, or both may not decode PDCCH candidates with a puncturing level or a type of rate matching (e.g., over the ALs having the non-negative power of two or over non-punctured CCEs) that the UE 115-a or the UE 115-b did not report a capability to monitor. As an example, in examples in which the UE 115-a did not report a capability to monitor PDCCH candidates in a CORESET in which the non-punctured CCEs were rate matched by the network entity 105 (e.g., without the punctured CCEs), the UE 115-a may not attempt to decode or decode the PDCCH candidates. The types of rate matching may be described in greater detail elsewhere herein, including with reference to FIG. 3B.

A quantity of CCE channel estimates may vary based on an AL, a type of rate matching, a puncturing level, or any combination thereof. For example, the UE 115-a, the UE 115-b, or both may have different PDCCH processing times for different combinations of the AL, the type of rate matching, and the puncturing level. As an example, the UE 115-a, the UE 115-b, or both may perform varying quantities of blind decoding attempts (e.g., have different quantities of blind decoding hypotheses) based on the different combinations of the AL, the type of rate matching, and the puncturing level (e.g., an effective AL).

The UE 115-a, the UE 115-b, or both may count a quantity of blind decoding attempts based on punctured PDCCH candidates. For example, the network entity 105 and the UE 115-a, the UE 115-b, or both may be configured to count the quantity of blind decoding attempts per PDCCH candidate. The quantity of blind decoding attempts may be configured such that the UE 115-a, the UE 115-b, or both may maintain a processing timeline. In some examples, the quantity of blind decoding attempts may be based on a level of puncturing. As an example, AL8 may correspond to blindly decoding AL6 with 2 punctured CCEs and ALS with 3 punctured CCEs. In other words, the UE 115-a, the UE 115-b, or both may perform a quantity of blind decoding attempts based on a quantity of un-punctured CCEs in the CORESET (e.g., an effective AL). Thus, the counting of blind decodes in CORESETs with punctured CCEs may be different from the counting of blind decodes in CORESETs without punctured CCEs.

FIG. 3A shows an example of a CORESET 300-a that supports techniques for indicating a CCE puncturing pattern in accordance with one or more aspects of the present disclosure. The CORESET 300-a may implement or be implemented by various aspects of the wireless communications system 100, the wireless communications system 200, or both. For example, the CORESET 300-a may illustrate and describe a set of punctured CCEs 320, which may be examples of the punctured CCE 220 as described with reference to FIG. 2. Additionally, or alternatively, the CORESET 300-a may be an example of a CORESET including one or more downlink control channel decoding candidates (e.g., PDCCH candidates) processed in order to decode a downlink control channel message (e.g., a PDCCH message), which may be an example of the downlink control channel messages 210 as described with reference to FIG. 2.

In some examples, a network entity may output control signaling indicating that one or more CCEs of a CORESET are to be punctured according to different granularity levels. For example, the control signaling may indicate one or more CCEs individually or, as illustrated in the example of FIG. 3A, according to groups of CCEs. For example, in the example CORESET 300-a of FIG. 3A, the CORESET 300-a may include multiple groups (e.g., disjoint groups) of CCEs. That is, the CORESET 300-a may include a group 310-a, a group 310-b, a group 310-c, a group 310-d, a group 310-c, a group 310-f, a group 310-g, and a group 310-h. While the groups 310 in the example of FIG. 3A include two CCEs each, it may be understood that the groups may include more than two CCEs each.

In examples in which a CORESET includes multiple groups, a network entity may transmit control signaling indicating one or more CCEs to be punctured of a CORESET according to the groups. For example, the network entity may transmit control signaling indicating one or more groups of the CORESET to be punctured. In the example of the CORESET 300-a, the network entity may transmit control signaling indicating that the group 310-b, the group 310-e, and the group 310-g are to be punctured. The groups of the CORESET to be punctured may be non-contiguous. That is, the group 310-b, the group 310-e, and the group 310-g in the example of FIG. 3A may not be contiguous. A UE, based on receiving the control signaling indicating that the group 310-b, the group 310-c, and the group 310-g are to be punctured, may determine that each CCE within the indicated groups are punctured.

FIG. 3B shows an example of a CORESET 300-b that supports techniques for indicating a CCE puncturing pattern in accordance with one or more aspects of the present disclosure. The CORESET 300-b may implement or be implemented by various aspects of the wireless communications system 100, the wireless communications system 200, or both. For example, the CORESET 300-b may illustrate and describe a set of punctured CCEs 320, which may examples of the punctured CCE 220 as described with reference to FIG. 2. Additionally, or alternatively, the CORESET 300-b may be an example of a CORESET including one or more downlink control channel decoding candidates (e.g., PDCCH candidates) processed in order to decode a downlink control channel message (e.g., a PDCCH message), which may be an example of the downlink control channel messages 210 as described with reference to FIG. 2.

A network entity may encode data according to various methods. For example, the network entity may puncture one or more CCEs after generation of a PDCCH or before generation of the PDCCH. As an example, the network entity may obtain an X-CCE punctured AL L PDCCH candidate by setting resource elements corresponding to X out of L CCEs to zero. In other words, the network entity may perform rate matching over CCEs of the CORESET 300-b (e.g., including punctured CCEs), where the punctured CCEs have corresponding resource elements which are muted. That is, rate matched CCEs 315-a may include both punctured and un-punctured CCEs of the CORESET 300-b.

Alternatively, the network entity may obtain an X-CCE punctured AL L PDCCH candidate by performing rate matching over a quantity of bits that can be conveyed in L-X CCEs. In other words, the network entity may perform rate matching over CCEs in the CORESET 300-b which are not punctured. That is, rate matched CCEs 315-b may include un-punctured CCEs of the CORESET 300-b. In examples in which the rate matched CCEs 315-b include the un-punctured CCEs of the CORESET 300-b, the network entity may perform the rate matching over the CCEs which are not punctured based on a capability of a UE. For example, a UE may transmit a capability message indicating whether the UE supports ALs different than ALs with non-negative powers of two. In some examples, the UE may transmit the capability message via a bit in a UCI message, an RRC message, or the like. Additionally, or alternatively, the network entity may signal whether the PDCCHs are punctured after generation (e.g., rate matched CCEs 315-a) or PDCCH generation over un-punctured CCEs (e.g., rate matched CCEs 315-b) such that UE may perform CCE processing accordingly.

Additionally, or alternatively, the network entity may indicate which CCEs are rate matched. For example, the UE may process PDCCH candidates of the CORESET based on which CCEs are rate matched by the network entity. As an example, the UE may process CCEs of the CORESET (e.g., all CCEs), where the punctured CCEs are muted. In another example, the UE may process a subset of CCEs of the CORESET, where the subset of CCEs excludes the punctured CCEs. In such cases, the UE may adjust the CCE channel estimates based on whether the UE processes the punctured CCEs or not.

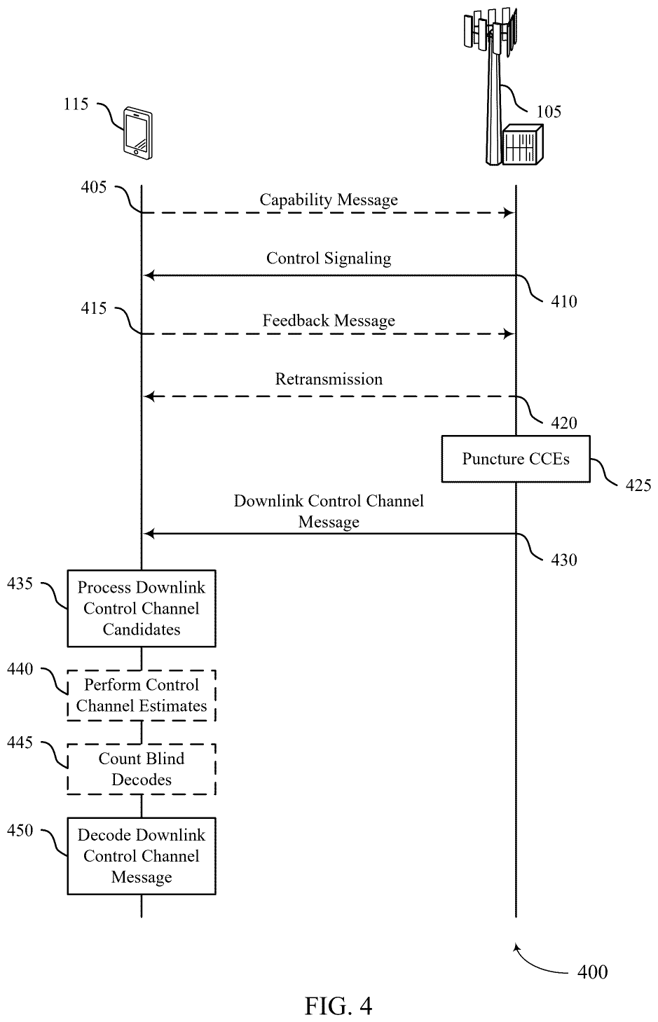

FIG. 4 shows an example of a process flow 400 that supports techniques for indicating a CCE puncturing pattern in accordance with one or more aspects of the present disclosure. In some examples, the process flow 400 may implement or be implemented by aspects of the wireless communications system 100, the CORESET 300-a, the CORESET 300-b, or any combination thereof. For example, the process flow 400 may include a network entity 105 and a UE 115, which may be examples of corresponding devices as illustrated by and described with reference to FIGS. 1 through 3.

Alternative examples of the following may be implemented. Some operations are performed in a different order than described or are not performed at all. In some cases, operations may include additional features not mentioned below, or further operations may be added. Although the network entity 105 and the UE 115 are shown performing the operations of the process flow 400, some aspects of some operations may also be performed by one or more other wireless communication devices.

At 405, the UE 115 may transmit a capability message. For example, the UE 115 may transmit a capability message associated with puncturing of CCEs. In some examples, the network entity 105 may determine a puncturing pattern, or determine a subset of CCEs to be punctured, based on the capability of the UE 115. Additionally, or alternatively, the capability message may include an indication that the UE 115 supports rate-matching over ALs associated with different powers of two or that the UE 115 supports rate matching over ALs different from the ALs associated with different powers of two.

At 410, the network entity 105 may output control signaling. For example, the UE 115 may receive control signaling including information that indicates that each CCE of a subset of CCEs within a CORESET is to be punctured. The network entity 105 may output the control signaling including the information that indicates that each CCE of the subset of CCES within the CORESET is to be punctured based on the capability message obtained at 405. The control signaling may include or be an example of the indication of the puncturing pattern 205 as described with reference to FIG. 2.

In some examples, the control signaling may include one or more RRC messages. For example, the UE 115 may receive one or more RRC messages including the information that indicates that each CCE of the subset of CCEs is to be punctured. Additionally, or alternatively, the control signaling may include a MAC-CE activation command. For example, the UE 115 may receive a MAC-CE activation command that activates a state that indicates that each CCE of the subset of CCEs is to be punctured. In other words, the UE 115 may be configured with multiple states, where each state corresponds to one or more CCEs to be punctured. The network entity 105 may activate a state to indicate which CCEs are to be punctured.

In some examples, the control signaling may include one or more DCI messages. For example, the UE 115 may receive one or more DCI messages including one or more DCI fields, where the DCI fields include the information that indicates that each CCE of the subset of CCEs is to be punctured. In a first example, the one or more DCI messages may be sent by the network entity 105 to a single UE, such as the UE 115. In other words, the network entity 105 may output the one or more DCI messages to the UE 115 via unicast signaling. In such examples, the one or more DCI messages may be associated with a DCI format, where the DCI format includes the one or more DCI fields including a set of indexes indicative of the subset of CCEs to be punctured, an indication of a position of a first CCE of the subset of CCEs and a quantity of contiguous CCEs to be punctured (e.g., for each contiguous group of CCEs in the subset), an indication of an entry in a table (e.g., for each contiguous group of CCEs in the subset), or any combination thereof.

Additionally, or alternatively, the control signaling may include a first DCI message, and the downlink control channel message may include a second DCI message. For example, the first DCI message may include an identifier of the CORESET (e.g., a CORESET Id) and the information that indicates that each CCE of the subset of CCEs within the CORESET is to be punctured.

In some examples, the control signaling may include a group-common or UE-specific downlink control message. For example, the group-common or UE-specific downlink control message may include a preemption indication, where the preemption indication includes the information that indicates that each CCE of the subset of CCEs is to be punctured. The network entity 105 may determine whether to output the group common or the UE-specific downlink control message based on whether the subset of CCEs to be punctured applies to a group of UEs monitoring downlink control channel candidates in the CORESET or to a single UE.

Additionally, or alternatively, the control signaling may indicate that a group of CCEs of multiple groups of CCEs within the CORESET are to be punctured. For example, the group of CCEs may include the subset of CCEs within the CORESET. In other words, the CORESET may be split into groups of CCEs, and the control signaling may indicate that one or more of the groups are to be punctured. The division of the CORESET into groups of CCEs may be illustrated and described in greater detail elsewhere herein, including with reference to FIG. 3A.

At 415, the UE 115 may transmit a feedback message. For example, the UE 115 may transmit the feedback message based on failing to decode the first DCI message before an expiration of a timer at the UE 115. That is, in examples in which the control signaling received at 410 includes the first DCI message, the UE 115 may transmit the feedback message if the UE 115 fails to decode the first DCI prior to the timer expiring. In other words, the UE 115 may transmit the feedback message based on failing to decode the control signaling within the duration of the timer.

At 420, the network entity 105 may output a retransmission. For example, the UE 115 may receive a retransmission of the control signaling. In some examples, the UE 115 may receive the retransmission of the control signaling based on transmitting the feedback message at 415. For example, the retransmission may be a retransmission of the first DCI message. Additionally, or alternatively, the network entity 105 may output multiple transmissions of the first DCI message (e.g., without or prior to obtaining the feedback message at 415). For example, the network entity 105 may output two or more transmissions of the first DCI message, where the two or more transmissions are associated with respective LLRs.

In such examples, the UE 115 may decode the first DCI message based on a combination of the respective LLRs associated with the two or more transmissions of the first DCI message. That is, in examples in which the network entity 105 outputs the two or more transmissions of the first DCI message, the UE 115 may decode the first DCI message by combining the LLRs of each transmission of the first DCI message. In other words, the UE 115 may perform LLR combining to decode the first DCI message.

At 425, the network entity 105 may puncture CCEs. For example, the network entity 105 may puncture each CCE of the subset of CCEs within the CORESET. That is, the network entity 105 may puncture each CCE according to the information that indicates that each CCE of the subset of CCEs within the CORESET is to be punctured output via the control signaling at 410.

In some examples, the network entity 105 may perform rate matching. For example, the network entity 105 may perform rate matching over a set of CCEs including the punctured CCEs, or over a subset of CCEs excluding the punctured CCEs. For example, the network entity 105 may rate match each CCE of a first downlink control channel candidate, where one or more of the rate matched CCEs of the first downlink control channel candidate are punctured in accordance with the information output via the control signaling at 410. Alternatively, the network entity 105 may rate match a subset of CCEs of the first downlink control channel candidate, where the subset excludes one or more CCEs of the first downlink control channel candidate that are punctured in accordance with the information output via the control signaling at 410.

At 430, the network entity 105 may output a downlink control channel message. For example, the network entity 105 may output the downlink control channel message via the CORESET based on puncturing each CCE of the subset of CCEs within the CORESET at 425. Additionally, or alternatively, the network entity 105 may output the downlink control channel message based on rate matching. In examples in which the downlink control channel message includes the second DCI message, the network entity 105 may output the second DCI message including a downlink grant associated with the UE 115 or a group of UEs including the UE 115. In such examples, a downlink control channel carrying the second DCI message may be punctured in accordance with the information of the first DCI message.

At 435, the UE 115 may process downlink control channel candidates. For example, the UE 115 may process, based on the information that indicates that each CCE of the subset is to be punctured, a set of downlink control channel candidates within the CORESET. In some examples, the UE 115 may process the downlink control channel candidates based on how the network entity 105 punctured the CCEs, such as whether the network entity 105 punctured the CCEs before or after generation of the downlink control channel message.

In a first example, the processing may include processing each CCE or a first downlink control channel candidate, where one or more of the processed CCEs of the first downlink control channel candidate are punctured in accordance with the information received via the control signaling at 410. Additionally, or alternatively, processing the one or more CCES that are punctured within the first downlink control channel candidate may include muting the one or more control channel candidates that are punctured within the first downlink control channel candidate. For example, in examples in which the network entity 105 punctures the CCEs after generation, the UE 115 may mute the control channel candidates that are punctured.

In a second example, the processing may include processing a subset of CCEs of a first downlink control channel candidate, where the subset excludes one or more control channel elements of the first downlink control channel candidate that are punctured in accordance with the information received via the control signaling. For example, in examples in which the network entity 105 generates the downlink control channel message over un-punctured CCES, the UE 115 may process the un-punctured CCEs.

At 440, the UE 115 may perform control channel estimates. For example, the UE 115 may perform a set of control channel estimates using CCEs within the CORESET based on the information that indicates that each CCE of the subset of CCEs is to be punctured. A quantity of control channel estimates may be based on an AL, a rate-matching option, a puncturing level, or any combination thereof. In some examples, the UE 115 may refrain from performing control channel elements using the subset of CCEs which are punctured. That is, based on the information in the control signaling indicating that each CCE of the subset of CCEs of the CORESET is to be punctured, the UE 115 may refrain from performing channel estimation for the punctured CCEs.

At 445, the UE 115 may count blind decodes. For example, the UE 115 may count a quantity of blind decodes based on the information that indicates that each CCE of the subset of CCEs is to be punctured. In some examples, the UE 115 and the network entity 105 may negotiate the quantity of blind decodes per downlink control channel candidate. For example, the UE 115 and the network entity 105 may agree to the quantity of blind decodes per downlink control channel candidate based on a level of puncturing.

At 450, the UE 115 may decode a downlink control channel message. For example, the UE 115 may decode the downlink control channel message based on processing the set of downlink control channel candidates at 435. In examples in which the control signaling received by the UE 115 at 410 includes the first DCI message and the downlink control channel message includes the second DCI message, the UE 115 may receive the second DCI message including a downlink grant or an uplink grant for communications associated with the UE 115.

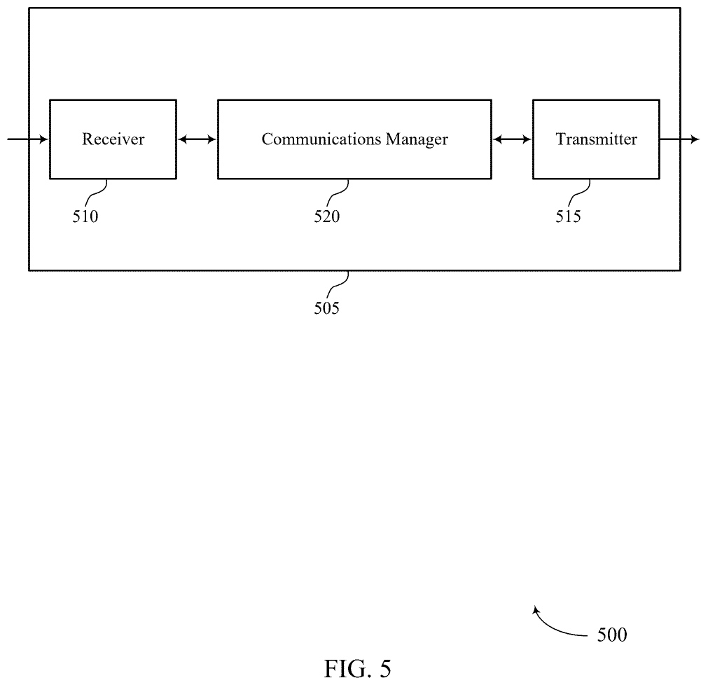

FIG. 5 shows a block diagram 500 of a device 505 that supports techniques for indicating a CCE puncturing pattern in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for indicating a CCE puncturing pattern). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for indicating a CCE puncturing pattern). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for indicating a CCE puncturing pattern as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving control signaling including information that indicates that each CCE of a subset of CCEs within a CORESET is to be punctured. The communications manager 520 is capable of, configured to, or operable to support a means for processing, based least in part on the information that indicates that each CCE of the subset is to be punctured, a set of downlink control channel candidates within the CORESET. The communications manager 520 is capable of, configured to, or operable to support a means for decoding a downlink control channel message based on processing the set of downlink control channel candidates.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources.

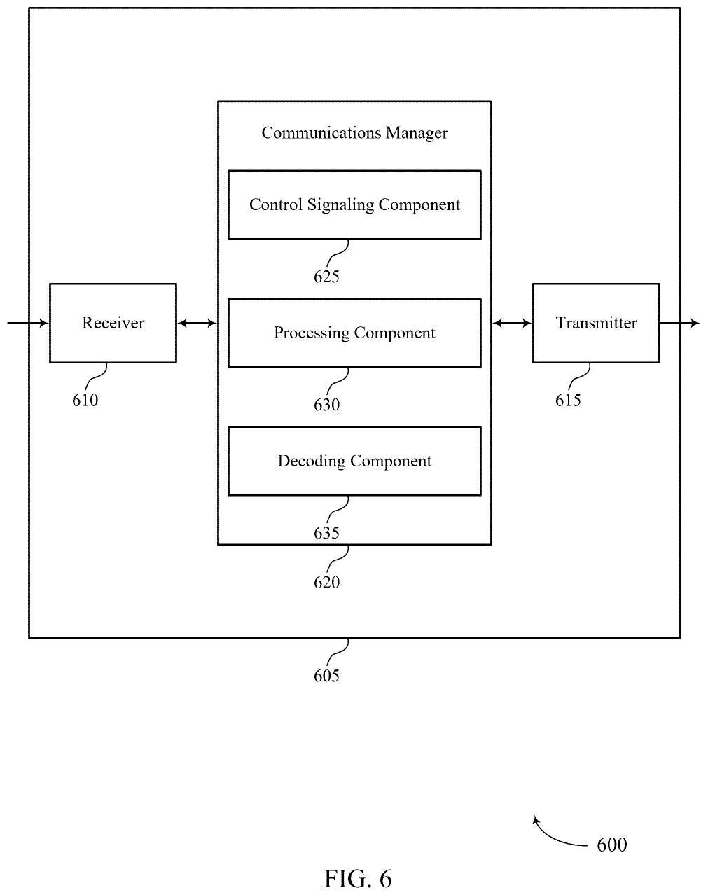

FIG. 6 shows a block diagram 600 of a device 605 that supports techniques for indicating a CCE puncturing pattern in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for indicating a CCE puncturing pattern). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for indicating a CCE puncturing pattern). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for indicating a CCE puncturing pattern as described herein. For example, the communications manager 620 may include a control signaling component 625, a processing component 630, a decoding component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The control signaling component 625 is capable of, configured to, or operable to support a means for receiving control signaling including information that indicates that each CCE of a subset of CCEs within a CORESET is to be punctured. The processing component 630 is capable of, configured to, or operable to support a means for processing, based least in part on the information that indicates that each CCE of the subset is to be punctured, a set of downlink control channel candidates within the CORESET. The decoding component 635 is capable of, configured to, or operable to support a means for decoding a downlink control channel message based on processing the set of downlink control channel candidates.

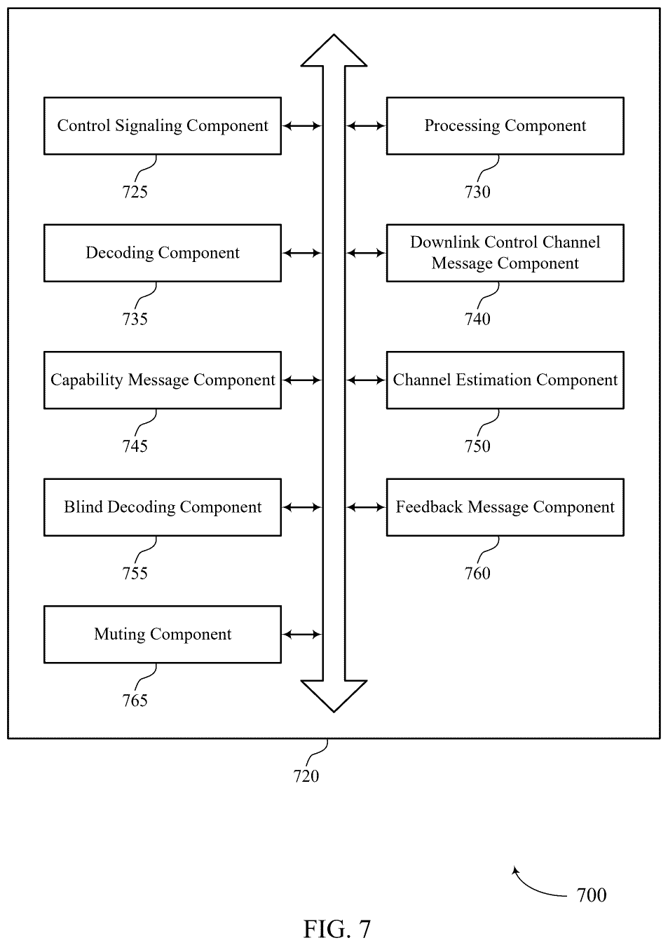

FIG. 7 shows a block diagram 700 of a communications manager 720 that supports techniques for indicating a CCE puncturing pattern in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for indicating a CCE puncturing pattern as described herein. For example, the communications manager 720 may include a control signaling component 725, a processing component 730, a decoding component 735, a downlink control channel message component 740, a capability message component 745, a channel estimation component 750, a blind decoding component 755, a feedback message component 760, a muting component 765, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The control signaling component 725 is capable of, configured to, or operable to support a means for receiving control signaling including information that indicates that each CCE of a subset of CCEs within a CORESET is to be punctured. The processing component 730 is capable of, configured to, or operable to support a means for processing, based least in part on the information that indicates that each CCE of the subset is to be punctured, a set of downlink control channel candidates within the CORESET. The decoding component 735 is capable of, configured to, or operable to support a means for decoding a downlink control channel message based on processing the set of downlink control channel candidates.

In some examples, to support receiving the control signaling, the control signaling component 725 is capable of, configured to, or operable to support a means for receiving one or more RRC messages including the information that indicates that each CCE of the subset of CCEs is to be punctured.

In some examples, to support receiving the control signaling, the control signaling component 725 is capable of, configured to, or operable to support a means for receiving a MAC-CE activation command, where the MAC-CE activation command activates a state that indicates that each CCE of the subset of CCEs is to be punctured.

In some examples, to support receiving the control signaling, the control signaling component 725 is capable of, configured to, or operable to support a means for receiving one or more DCI messages including one or more DCI fields, where the one or more DCI fields include the information that indicates that each CCE of the subset of CCEs is to be punctured.

In some examples, the one or more DCI messages are associated with a DCI format. In some examples, the DCI format includes the one or more DCI fields including a set of indexes indicative of the subset of CCEs to be punctured, one or more first indications of respective positions of first control channel elements of the subset of control channel elements and respective quantities of contiguous control channel elements punctured, one or more second indications of respective entries in a table, or any combination thereof.

In some examples, to support receiving the control signaling, the control signaling component 725 is capable of, configured to, or operable to support a means for receiving a first DCI message including an identifier of the CORESET and the information that indicates that each CCE of the subset of CCEs within the CORESET is to be punctured, and where decoding the downlink control channel message includes receiving a second DCI message including a downlink grant or uplink grant for communications associated with the UE.

In some examples, to support receiving the control signaling, the control signaling component 725 is capable of, configured to, or operable to support a means for receiving two or more transmissions of the first DCI message, where the two or more transmissions are associated with respective LLRs. In some examples, to support receiving the control signaling, the decoding component 735 is capable of, configured to, or operable to support a means for decoding the first DCI message based on a combination of the respective LLRs associated with the two or more transmissions.

In some examples, the feedback message component 760 is capable of, configured to, or operable to support a means for transmitting a feedback message based on failing to decode the first DCI message before an expiration of a timer at the UE. In some examples, the control signaling component 725 is capable of, configured to, or operable to support a means for receiving a retransmission of the first DCI message based on transmitting the feedback message.

In some examples, to support receiving the control signaling, the control signaling component 725 is capable of, configured to, or operable to support a means for receiving a group-common or UE-specific downlink control message including a preemption indication, where the preemption indication includes the information that indicates that each CCE of the subset of CCEs is to be punctured.

In some examples, to support receiving the control signaling, the control signaling component 725 is capable of, configured to, or operable to support a means for receiving the information that indicates that a group of CCEs of a set of multiple groups of CCEs within the CORESET is to be punctured, where the group includes the subset of CCEs within the CORESET.

In some examples, to support processing the set of downlink control channel candidates, the processing component 730 is capable of, configured to, or operable to support a means for processing each CCE of a first downlink control channel candidate, where one or more of the processed CCEs of the first downlink control channel candidate are punctured in accordance with the information received via the control signaling.

In some examples, to support processing the one or more CCEs that are punctured within the first downlink control channel candidate, the muting component 765 is capable of, configured to, or operable to support a means for muting the one or more control channel candidates that are punctured within the first downlink control channel candidate.

In some examples, to support processing the set of downlink control channel candidates, the processing component 730 is capable of, configured to, or operable to support a means for processing a subset of CCEs of a first downlink control channel candidate, where the subset excludes one or more CCEs of the first downlink control channel candidate that are punctured in accordance with the information received via the control signaling.

In some examples, the capability message component 745 is capable of, configured to, or operable to support a means for transmitting a capability message associated with puncturing of CCEs, where receiving the control signaling including the information that indicates that each CCE of the subset of CCEs within the CORESET is to be punctured is based on the capability message.

In some examples, the capability message includes an indication that the UE supports rate-matching over ALs associated with different powers of two or that the UE supports rate-matching over ALs different from the ALs associated with different powers of two.

In some examples, the channel estimation component 750 is capable of, configured to, or operable to support a means for performing a set of control channel estimates using CCEs within the CORESET based on the information that indicates that each CCE of the subset of CCEs is to be punctured.

In some examples, the blind decoding component 755 is capable of, configured to, or operable to support a means for counting a quantity of blind decodes based on the information that indicates that each CCE of the subset of CCEs is to be punctured.

In some examples, the subset of control channel elements of the control resource set comprises one or more contiguous control channel elements of the control resource set, one or more non-contiguous control channel elements in the control resource set, or both the one or more contiguous control channel elements and the one or more non-contiguous control channel elements.

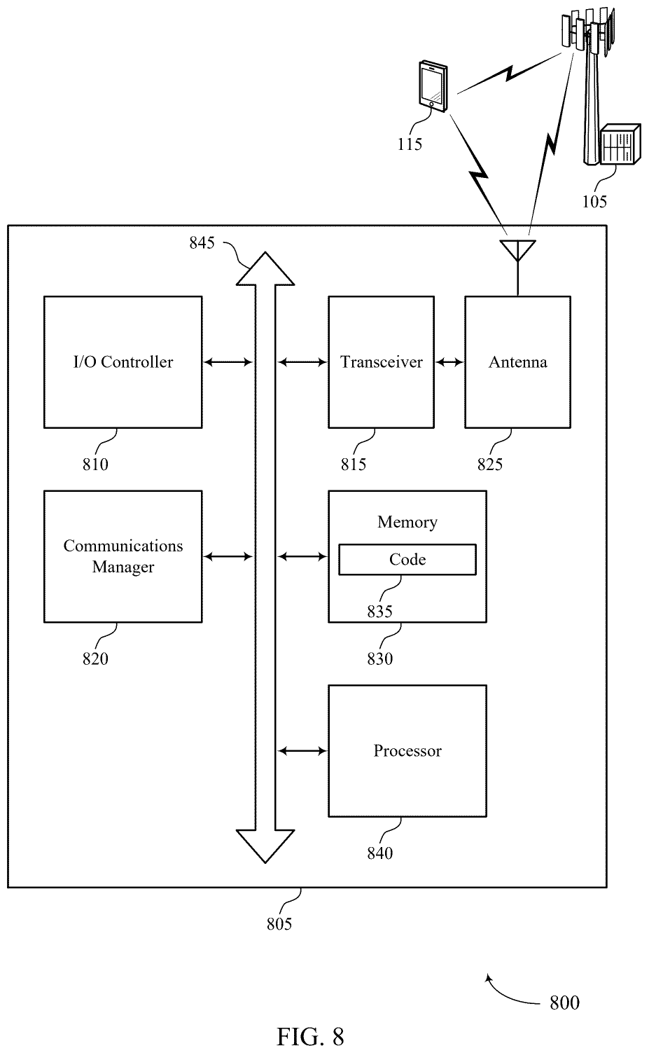

FIG. 8 shows a diagram of a system 800 including a device 805 that supports techniques for indicating a CCE puncturing pattern in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for indicating a CCE puncturing pattern). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving control signaling including information that indicates that each CCE of a subset of CCEs within a CORESET is to be punctured. The communications manager 820 is capable of, configured to, or operable to support a means for processing, based least in part on the information that indicates that each CCE of the subset is to be punctured, a set of downlink control channel candidates within the CORESET. The communications manager 820 is capable of, configured to, or operable to support a means for decoding a downlink control channel message based on processing the set of downlink control channel candidates.

By including or configuring the communications manager 820 in accordance with examples as described herein, the device 805 may support techniques for reduced power consumption and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for indicating a CCE puncturing pattern as described herein, or the at least one processor 840 and the at least one memory 830 may be otherwise configured to, individually or collectively, perform or support such operations.

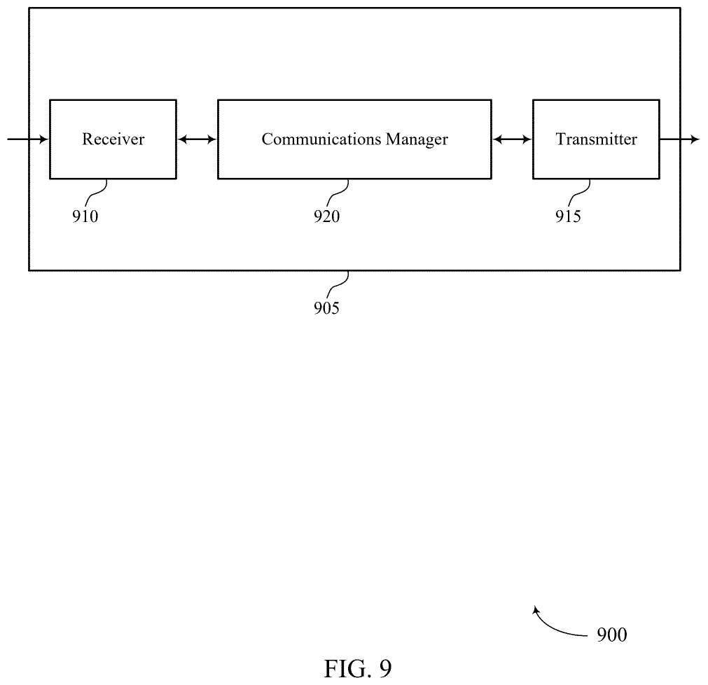

FIG. 9 shows a block diagram 900 of a device 905 that supports techniques for indicating a CCE puncturing pattern in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for indicating a CCE puncturing pattern as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting control signaling including information that indicates that each CCE of a subset of CCEs within a CORESET is to be punctured. The communications manager 920 is capable of, configured to, or operable to support a means for outputting, via the CORESET, a downlink control channel message based on puncturing each CCE of the subset of CCEs within the CORESET.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, and more efficient utilization of communication resources.

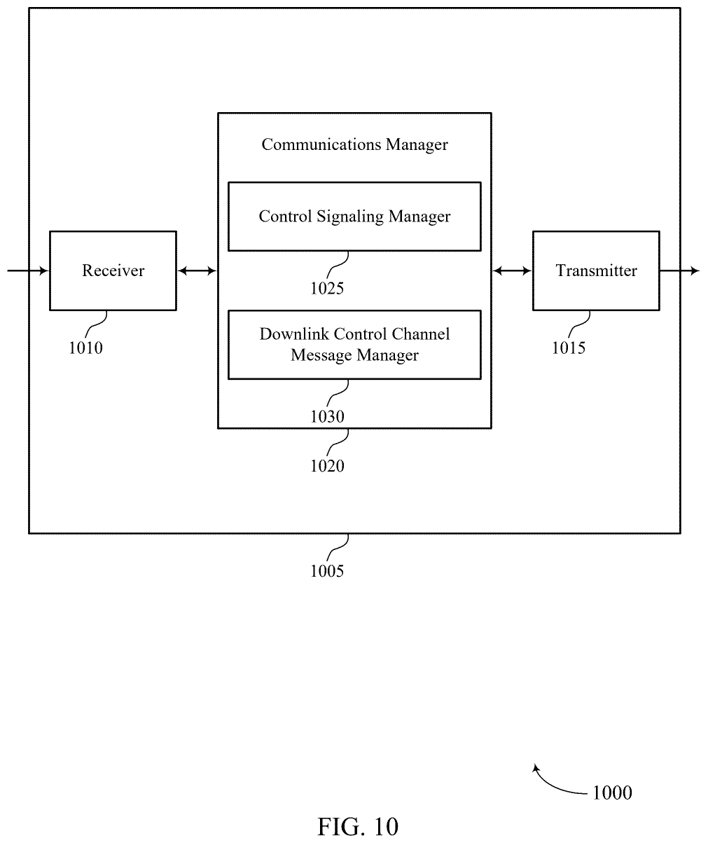

FIG. 10 shows a block diagram 1000 of a device 1005 that supports techniques for indicating a CCE puncturing pattern in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for indicating a CCE puncturing pattern as described herein. For example, the communications manager 1020 may include a control signaling manager 1025 a downlink control channel message manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The control signaling manager 1025 is capable of, configured to, or operable to support a means for outputting control signaling including information that indicates that each CCE of a subset of CCEs within a CORESET is to be punctured. The downlink control channel message manager 1030 is capable of, configured to, or operable to support a means for outputting, via the CORESET, a downlink control channel message based on puncturing each CCE of the subset of CCEs within the CORESET.

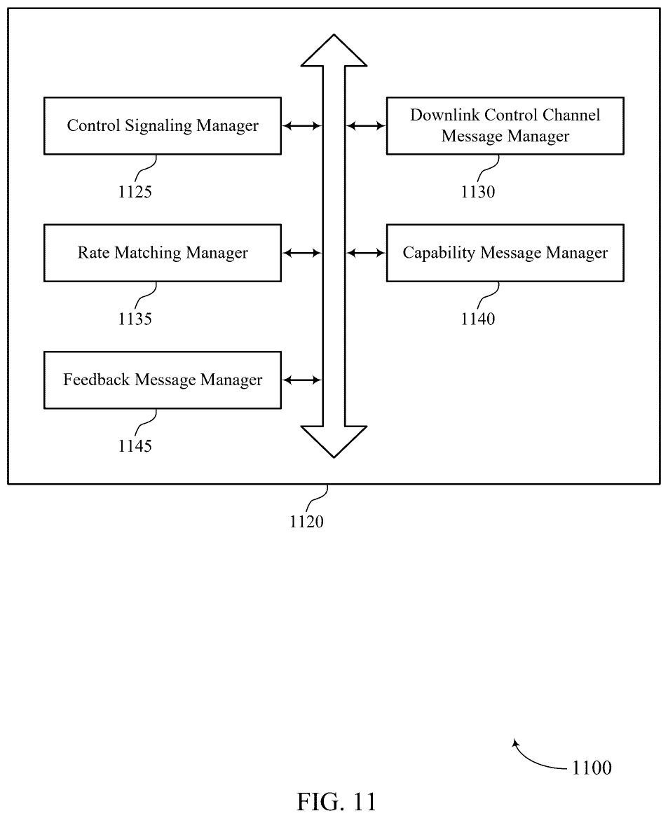

FIG. 11 shows a block diagram 1100 of a communications manager 1120 that supports techniques for indicating a CCE puncturing pattern in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for indicating a CCE puncturing pattern as described herein. For example, the communications manager 1120 may include a control signaling manager 1125, a downlink control channel message manager 1130, a rate matching manager 1135, a capability message manager 1140, a feedback message manager 1145, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The control signaling manager 1125 is capable of, configured to, or operable to support a means for outputting control signaling including information that indicates that each CCE of a subset of CCEs within a CORESET is to be punctured. The downlink control channel message manager 1130 is capable of, configured to, or operable to support a means for outputting, via the CORESET, a downlink control channel message based on puncturing each CCE of the subset of CCEs within the CORESET.

In some examples, to support outputting the control signaling, the control signaling manager 1125 is capable of, configured to, or operable to support a means for outputting one or more RRC messages including the information that indicates that each CCE of the subset of CCEs is to be punctured.

In some examples, to support outputting the control signaling, the control signaling manager 1125 is capable of, configured to, or operable to support a means for outputting a MAC-CE activation command, where the MAC-CE activation command activates a state that indicates that each CCE of the subset of CCEs is to be punctured.

In some examples, to support outputting the control signaling, the control signaling manager 1125 is capable of, configured to, or operable to support a means for outputting one or more DCI messages including one or more DCI fields, where the one or more DCI fields include the information that indicates that each CCE of the subset of CCEs is to be punctured.

In some examples, the one or more DCI messages are associated with a DCI format. In some examples, the DCI format includes the one or more DCI fields including a set of indexes indicative of the subset of CCEs to be punctured, one or more first indications of respective positions of first control channel elements of the subset of control channel elements and respective quantities of contiguous control channel elements punctured, one or more second indications of respective entries in a table, or any combination thereof.

In some examples, to support outputting the control signaling, the control signaling manager 1125 is capable of, configured to, or operable to support a means for outputting a first DCI message including an identifier of the CORESET and the information that indicates that each CCE of the subset of CCEs within the CORESET is to be punctured, and where outputting the downlink control channel message includes outputting a second DCI message including a downlink grant associated with a UE or a group of UEs, where a downlink control channel carrying the second DCI message is punctured in accordance with the information of the first DCI message.

In some examples, to support outputting the control signaling, the control signaling manager 1125 is capable of, configured to, or operable to support a means for outputting two or more transmissions of the first DCI message, where the two or more transmissions are associated with respective LLRs

In some examples, the feedback message manager 1145 is capable of, configured to, or operable to support a means for obtaining a feedback message. In some examples, the control signaling manager 1125 is capable of, configured to, or operable to support a means for outputting a retransmission of the first DCI message based on obtaining the feedback message.

In some examples, to support outputting the control signaling, the control signaling manager 1125 is capable of, configured to, or operable to support a means for outputting a group-common or UE-specific downlink control message including a preemption indication, where the preemption indication includes the information that indicates that each CCE of the subset of CCEs is to be punctured.

In some examples, to support outputting the control signaling, the control signaling manager 1125 is capable of, configured to, or operable to support a means for outputting the information that indicates that a group of CCEs of a set of multiple groups of CCEs within the CORESET is to be punctured, where the group includes the subset of CCEs within the CORESET.

In some examples, the rate matching manager 1135 is capable of, configured to, or operable to support a means for rate matching each CCE of a first downlink control channel candidate, where one or more of the rate matched CCEs of the first downlink control channel candidate are punctured in accordance with the information output via the control signaling, and where outputting the downlink control channel message is based on the rate matching.

In some examples, the rate matching manager 1135 is capable of, configured to, or operable to support a means for rate matching a subset of CCEs of a first downlink control channel candidate, where the subset excludes one or more CCEs of the first downlink control channel candidate that are punctured in accordance with the information output via the control signaling, and where outputting the downlink control channel message is based on the rate matching.

In some examples, the capability message manager 1140 is capable of, configured to, or operable to support a means for obtaining a capability message associated with puncturing of CCEs, where outputting the control signaling including the information that indicates that each CCE of the subset of CCEs within the CORESET is to be punctured is based on the capability message.

In some examples, the capability message includes an indication that a UE supports rate-matching over ALs associated with different powers of two or that the UE supports rate-matching over ALs different from the ALs associated with different powers of two.

In some examples, the subset of control channel elements of the control resource set comprises one or more contiguous control channel elements of the control resource set, one or more non-contiguous control channel elements in the control resource set, or both the one or more contiguous control channel elements and the one or more non-contiguous control channel elements.

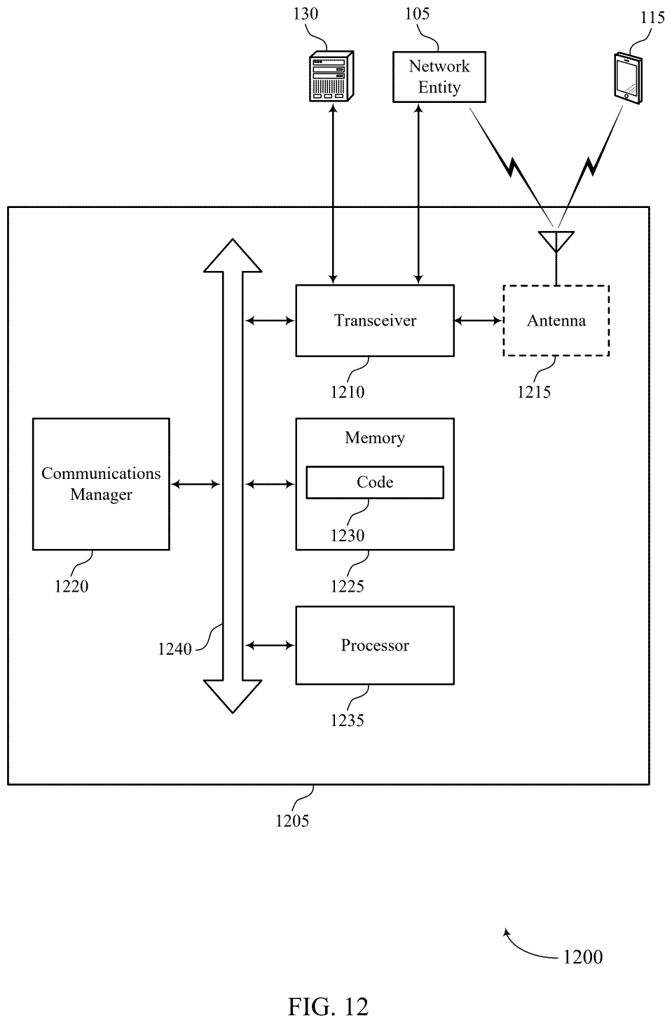

FIG. 12 shows a diagram of a system 1200 including a device 1205 that supports techniques for indicating a CCE puncturing pattern in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for indicating a CCE puncturing pattern). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting control signaling including information that indicates that each CCE of a subset of CCEs within a CORESET is to be punctured. The communications manager 1220 is capable of, configured to, or operable to support a means for outputting, via the CORESET, a downlink control channel message based on puncturing each CCE of the subset of CCEs within the CORESET.

By including or configuring the communications manager 1220 in accordance with examples as described herein, the device 1205 may support techniques for reduced power consumption and more efficient utilization of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for indicating a CCE puncturing pattern as described herein, or the at least one processor 1235 and the at least one memory 1225 may be otherwise configured to, individually or collectively, perform or support such operations.

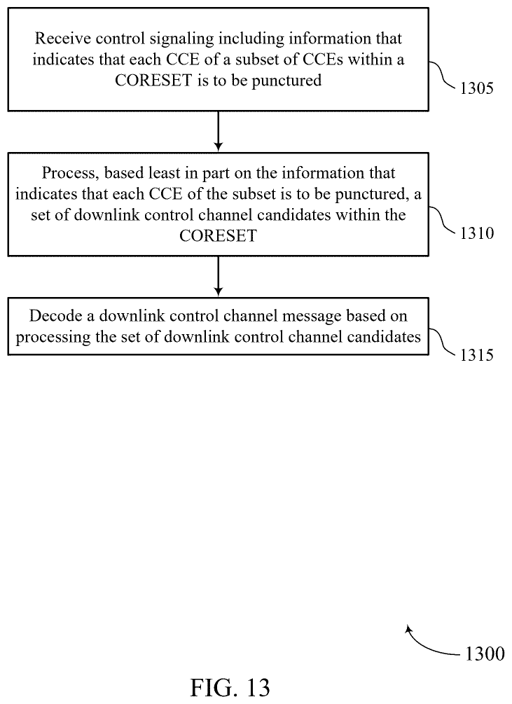

FIG. 13 shows a flowchart illustrating a method 1300 that supports techniques for indicating a CCE puncturing pattern in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving control signaling including information that indicates that each CCE of a subset of CCEs within a CORESET is to be punctured. The operations of 1305 may be performed in accordance with examples as disclosed herein. In some examples, aspects of the operations of 1305 may be performed by a control signaling component 725 as described with reference to FIG. 7.

At 1310, the method may include processing, based least in part on the information that indicates that each CCE of the subset is to be punctured, a set of downlink control channel candidates within the CORESET. The operations of 1310 may be performed in accordance with examples as disclosed herein. In some examples, aspects of the operations of 1310 may be performed by a processing component 730 as described with reference to FIG. 7.

At 1315, the method may include decoding a downlink control channel message based on processing the set of downlink control channel candidates. The operations of 1315 may be performed in accordance with examples as disclosed herein. In some examples, aspects of the operations of 1315 may be performed by a decoding component 735 as described with reference to FIG. 7.

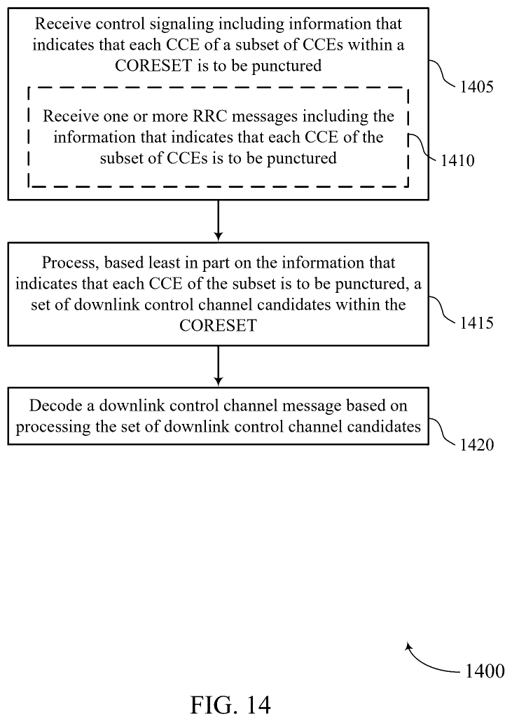

FIG. 14 shows a flowchart illustrating a method 1400 that supports techniques for indicating a CCE puncturing pattern in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving control signaling including information that indicates that each CCE of a subset of CCEs within a CORESET is to be punctured. The operations of 1405 may be performed in accordance with examples as disclosed herein. In some examples, aspects of the operations of 1405 may be performed by a control signaling component 725 as described with reference to FIG. 7.

At 1410, receiving the control signaling may include receiving one or more RRC messages including the information that indicates that each CCE of the subset of CCEs is to be punctured. The operations of 1410 may be performed in accordance with examples as disclosed herein. In some examples, aspects of the operations of 1410 may be performed by a control signaling component 725 as described with reference to FIG. 7.

At 1415, the method may include processing, based least in part on the information that indicates that each CCE of the subset is to be punctured, a set of downlink control channel candidates within the CORESET. The operations of 1415 may be performed in accordance with examples as disclosed herein. In some examples, aspects of the operations of 1415 may be performed by a processing component 730 as described with reference to FIG. 7.

At 1420, the method may include decoding a downlink control channel message based on processing the set of downlink control channel candidates. The operations of 1420 may be performed in accordance with examples as disclosed herein. In some examples, aspects of the operations of 1420 may be performed by a decoding component 735 as described with reference to FIG. 7.

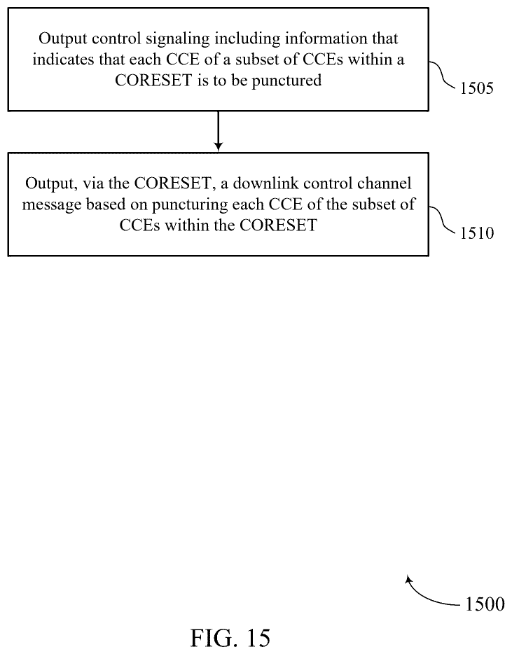

FIG. 15 shows a flowchart illustrating a method 1500 that supports techniques for indicating a CCE puncturing pattern in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include outputting control signaling including information that indicates that each CCE of a subset of CCEs within a CORESET is to be punctured. The operations of 1505 may be performed in accordance with examples as disclosed herein. In some examples, aspects of the operations of 1505 may be performed by a control signaling manager 1125 as described with reference to FIG. 11.

At 1510, the method may include outputting, via the CORESET, a downlink control channel message based on puncturing each CCE of the subset of CCEs within the CORESET. The operations of 1510 may be performed in accordance with examples as disclosed herein. In some examples, aspects of the operations of 1510 may be performed by a downlink control channel message manager 1130 as described with reference to FIG. 11.

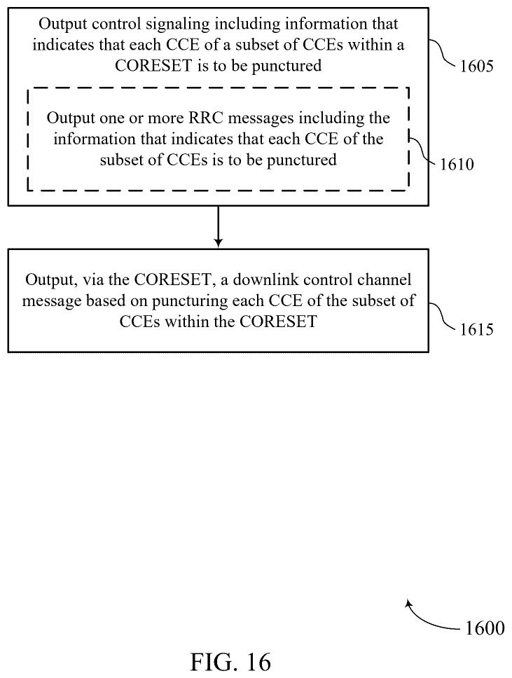

FIG. 16 shows a flowchart illustrating a method 1600 that supports techniques for indicating a CCE puncturing pattern in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting control signaling including information that indicates that each CCE of a subset of CCEs within a CORESET is to be punctured. The operations of 1605 may be performed in accordance with examples as disclosed herein. In some examples, aspects of the operations of 1605 may be performed by a control signaling manager 1125 as described with reference to FIG. 11.

At 1610, outputting the control signaling may include outputting one or more RRC messages including the information that indicates that each CCE of the subset of CCEs is to be punctured. The operations of 1610 may be performed in accordance with examples as disclosed herein. In some examples, aspects of the operations of 1610 may be performed by a control signaling manager 1125 as described with reference to FIG. 11.

At 1615, the method may include outputting, via the CORESET, a downlink control channel message based on puncturing each CCE of the subset of CCEs within the CORESET. The operations of 1615 may be performed in accordance with examples as disclosed herein. In some examples, aspects of the operations of 1615 may be performed by a downlink control channel message manager 1130 as described with reference to FIG. 11.

The following provides an overview of aspects of the present disclosure:

Aspect 1: A method for wireless communications at a UE, comprising: receiving control signaling comprising information that indicates that each CCE of a subset of CCEs within a CORESET is to be punctured; processing, based least in part on the information that indicates that each CCE of the subset is to be punctured, a set of downlink control channel candidates within the CORESET; and decoding a downlink control channel message based at least in part on processing the set of downlink control channel candidates.

Aspect 2: The method of aspect 1, wherein receiving the control signaling comprises: receiving one or more RRC messages comprising the information that indicates that each CCE of the subset of CCEs is to be punctured.

Aspect 3: The method of any of aspects 1 through 2, wherein receiving the control signaling comprises: receiving a MAC-CE activation command, wherein the MAC-CE activation command activates a state that indicates that each CCE of the subset of CCEs is to be punctured.

Aspect 4: The method of any of aspects 1 through 3, wherein receiving the control signaling comprises: receiving one or more DCI messages comprising one or more DCI fields, wherein the one or more DCI fields comprise the information that indicates that each CCE of the subset of CCEs is to be punctured.

Aspect 5: The method of aspect 4, wherein the one or more DCI messages are associated with a DCI format, the DCI format comprises the one or more DCI fields including a set of indexes indicative of the subset of CCEs to be punctured, one or more first indications of respective positions of first control channel elements of the subset of control channel elements and respective quantities of contiguous control channel elements punctured, one or more second indications of respective entries in a table, or any combination thereof.

Aspect 6: The method of any of aspects 1 through 5, wherein receiving the control signaling comprises: receiving a first DCI message comprising an identifier of the CORESET and the information that indicates that each CCE of the subset of CCEs within the CORESET is to be punctured, and wherein decoding the downlink control channel message comprises: receiving a second DCI message comprising a downlink grant or uplink grant for communications associated with the UE.

Aspect 7: The method of aspect 6, wherein receiving the control signaling further comprises: receiving two or more transmissions of the first DCI message, wherein the two or more transmissions are associated with respective LLRs; and decoding the first DCI message based at least in part on a combination of the respective LLRs associated with the two or more transmissions.

Aspect 8: The method of any of aspects 6 through 7, further comprising: transmitting a feedback message based at least in part on failing to decode the first DCI message before an expiration of a timer at the UE; and receiving a retransmission of the first DCI message based at least in part on transmitting the feedback message.

Aspect 9: The method of any of aspects 1 through 8, wherein receiving the control signaling comprises: receiving a group-common or UE-specific downlink control message comprising a preemption indication, wherein the preemption indication comprises the information that indicates that each CCE of the subset of CCEs is to be punctured.

Aspect 10: The method of any of aspects 1 through 9, wherein receiving the control signaling comprises: receiving the information that indicates that a group of CCEs of a plurality of groups of CCEs within the CORESET is to be punctured, wherein the group comprises the subset of CCEs within the CORESET.

Aspect 11: The method of any of aspects 1 through 10, wherein processing the set of downlink control channel candidates comprises: processing each CCE of a first downlink control channel candidate, wherein one or more of the processed CCEs of the first downlink control channel candidate are punctured in accordance with the information received via the control signaling.

Aspect 12: The method of aspect 11, wherein processing the one or more CCEs that are punctured within the first downlink control channel candidate comprises: muting the one or more control channel candidates that are punctured within the first downlink control channel candidate.

Aspect 13: The method of any of aspects 1 through 12, wherein processing the set of downlink control channel candidates comprises: processing a subset of CCEs of a first downlink control channel candidate, wherein the subset excludes one or more CCEs of the first downlink control channel candidate that are punctured in accordance with the information received via the control signaling.

Aspect 14: The method of any of aspects 1 through 13, further comprising: transmitting a capability message associated with puncturing of CCEs, wherein receiving the control signaling comprising the information that indicates that each CCE of the subset of CCEs within the CORESET is to be punctured is based at least in part on the capability message.

Aspect 15: The method of aspect 14, wherein the capability message comprises an indication that the UE supports rate-matching over aggregation levels associated with different powers of two or that the UE supports rate-matching over aggregation levels different from the aggregation levels associated with different powers of two.

Aspect 16: The method of any of aspects 1 through 15, further comprising: performing a set of control channel estimates using CCEs within the CORESET based at least in part on the information that indicates that each CCE of the subset of CCEs is to be punctured.

Aspect 17: The method of any of aspects 1 through 16, further comprising: counting a quantity of blind decodes based at least in part on the information that indicates that each CCE of the subset of CCEs is to be punctured.

Aspect 18: The method of any of aspects 1 through 17, wherein the subset of CCEs of the CORESET comprises one or more contiguous CCEs of the control resource set, one or more non-contiguous CCEs in the CORESET, or both the one or more contiguous CCEs and the one or more non-contiguous CCEs.

Aspect 19: A method for wireless communications at a network entity, comprising: outputting control signaling comprising information that indicates that each CCE of a subset of CCEs within a CORESET is to be punctured; and outputting, via the CORESET, a downlink control channel message based at least in part on puncturing each CCE of the subset of CCEs within the CORESET.

Aspect 20: The method of aspect 19, wherein outputting the control signaling comprises: outputting one or more RRC messages comprising the information that indicates that each CCE of the subset of CCEs is to be punctured.

Aspect 21: The method of any of aspects 19 through 20, wherein outputting the control signaling comprises: outputting a MAC-CE activation command, wherein the MAC-CE activation command activates a state that indicates that each CCE of the subset of CCEs is to be punctured.

Aspect 22: The method of any of aspects 19 through 21, wherein outputting the control signaling comprises: outputting one or more DCI messages comprising one or more DCI fields, wherein the one or more DCI fields comprise the information that indicates that each CCE of the subset of CCEs is to be punctured.

Aspect 23: The method of aspect 22, wherein the one or more DCI messages are associated with a DCI format, the DCI format comprises the one or more DCI fields including a set of indexes indicative of the subset of CCEs to be punctured, one or more first indications of respective positions of first control channel elements of the subset of control channel elements and respective quantities of contiguous control channel elements punctured, one or more second indications of respective entries in a table, or any combination thereof.

Aspect 24: The method of any of aspects 19 through 23, wherein outputting the control signaling comprises: outputting a first DCI message comprising an identifier of the CORESET and the information that indicates that each CCE of the subset of CCEs within the CORESET is to be punctured, and wherein outputting the downlink control channel message comprises: outputting a second DCI message comprising a downlink grant associated with a UE or a group of UEs, wherein a downlink control channel carrying the second DCI message is punctured in accordance with the information of the first DCI message.

Aspect 25: The method of aspect 24, wherein outputting the control signaling further comprises: outputting two or more transmissions of the first DCI message, wherein the two or more transmissions are associated with respective LLRs.

Aspect 26: The method of any of aspects 24 through 25, further comprising: obtaining a feedback message; and outputting a retransmission of the first DCI message based at least in part on obtaining the feedback message.

Aspect 27: The method of any of aspects 19 through 26, wherein outputting the control signaling comprises: outputting a group-common or UE-specific downlink control message comprising a preemption indication, wherein the preemption indication comprises the information that indicates that each CCE of the subset of CCEs is to be punctured.

Aspect 28: The method of any of aspects 19 through 27, wherein outputting the control signaling comprises: outputting the information that indicates that a group of CCEs of a plurality of groups of CCEs within the CORESET is to be punctured, wherein the group comprises the subset of CCEs within the CORESET.

Aspect 29: The method of any of aspects 19 through 28, further comprising: rate matching each CCE of a first downlink control channel candidate, wherein one or more of the rate matched CCEs of the first downlink control channel candidate are punctured in accordance with the information output via the control signaling, and wherein outputting the downlink control channel message is based at least in part on the rate matching.

Aspect 30: The method of any of aspects 19 through 29, further comprising: rate matching a subset of CCEs of a first downlink control channel candidate, wherein the subset excludes one or more CCEs of the first downlink control channel candidate that are punctured in accordance with the information output via the control signaling, and wherein outputting the downlink control channel message is based at least in part on the rate matching.

Aspect 31: The method of any of aspects 19 through 30, further comprising: obtaining a capability message associated with puncturing of CCEs, wherein outputting the control signaling comprising the information that indicates that each CCE of the subset of CCEs within the CORESET is to be punctured is based at least in part on the capability message.

Aspect 32: The method of aspect 31, wherein the capability message comprises an indication that a UE supports rate-matching over aggregation levels associated with different powers of two or that the UE supports rate-matching over aggregation levels different from the aggregation levels associated with different powers of two.

Aspect 33: The method of any of aspects 19 through 32, wherein the subset of CCEs of the CORESET comprises one or more contiguous CCEs of the control resource set, one or more non-contiguous CCEs in the CORESET, or both the one or more contiguous CCEs and the one or more non-contiguous CCEs.

Aspect 34: A UE for wireless communications, comprising one or more memories storing processor-executable code, and one or more processors coupled with the one or more memories and individually or collectively operable to execute the code to cause the UE to perform a method of any of aspects 1 through 18.

Aspect 35: A UE for wireless communications, comprising at least one means for performing a method of any of aspects 1 through 18.

Aspect 36: A non-transitory computer-readable medium storing code for wireless communications, the code comprising instructions executable by one or more processors to perform a method of any of aspects 1 through 18.

Aspect 37: A network entity for wireless communications, comprising one or more memories storing processor-executable code, and one or more processors coupled with the one or more memories and individually or collectively operable to execute the code to cause the network entity to perform a method of any of aspects 19 through 33.

Aspect 38: A network entity for wireless communications, comprising at least one means for performing a method of any of aspects 19 through 33.

Aspect 39: A non-transitory computer-readable medium storing code for wireless communications, the code comprising instructions executable by one or more processors to perform a method of any of aspects 19 through 33.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling comprising information that indicates that each control channel element of a subset of control channel elements within a control resource set is to be punctured;
process, based least in part on the information that indicates that each control channel element of the subset is to be punctured, a set of downlink control channel candidates within the control resource set; and
decode a downlink control channel message based at least in part on processing the set of downlink control channel candidates.

2. The UE of claim 1, wherein, to receive the control signaling, the one or more processors are individually or collectively operable to execute the code to cause the UE to:
receive one or more radio resource control (RRC) messages comprising the information that indicates that each control channel element of the subset of control channel elements is to be punctured.

3. The UE of claim 1, wherein, to receive the control signaling, the one or more processors are individually or collectively operable to execute the code to cause the UE to:
receive a medium access control (MAC)-control element (CE) activation command, wherein the MAC-CE activation command activates a state that indicates that each control channel element of the subset of control channel elements is to be punctured.

4. The UE of claim 1, wherein, to receive the control signaling, the one or more processors are individually or collectively operable to execute the code to cause the UE to:
receive one or more downlink control information (DCI) messages comprising one or more DCI fields, wherein the one or more DCI fields comprise the information that indicates that each control channel element of the subset of control channel elements is to be punctured.

5. The UE of claim 4, wherein:
the one or more DCI messages are associated with a DCI format, and
the DCI format comprises the one or more DCI fields including a set of indexes indicative of the subset of control channel elements to be punctured, one or more first indications of respective positions of first control channel elements of the subset of control channel elements and respective quantities of contiguous control channel elements punctured, one or more second indications of respective entries in a table, or any combination thereof.

6. The UE of claim 1, wherein, to receive the control signaling, the one or more processors are individually or collectively operable to execute the code to cause the UE to:
receive a first downlink control information (DCI) message comprising an identifier of the control resource set and the information that indicates that each control channel element of the subset of control channel elements within the control resource set is to be punctured, and wherein to decode the downlink control channel message, the one or more processors are individually or collectively operable to execute the code to cause the UE to:
receive a second DCI message comprising a downlink grant or uplink grant for communications associated with the UE.

7. The UE of claim 6, wherein, to receive the control signaling, the one or more processors are individually or collectively further operable to execute the code to cause the UE to:
receive two or more transmissions of the first DCI message, wherein the two or more transmissions are associated with respective log-likelihood ratios (LLRs); and
decode the first DCI message based at least in part on a combination of the respective LLRs associated with the two or more transmissions.

8. The UE of claim 6, wherein the one or more processors are individually or collectively further operable to execute the code to cause the UE to:
transmit a feedback message based at least in part on failing to decode the first DCI message before an expiration of a timer at the UE; and
receive a retransmission of the first DCI message based at least in part on transmitting the feedback message.

9. The UE of claim 1, wherein, to receive the control signaling, the one or more processors are individually or collectively operable to execute the code to cause the UE to:
receive a group-common or UE-specific downlink control message comprising a preemption indication, wherein the preemption indication comprises the information that indicates that each control channel element of the subset of control channel elements is to be punctured.

10. The UE of claim 1, wherein, to receive the control signaling, the one or more processors are individually or collectively operable to execute the code to cause the UE to:
receive the information that indicates that a group of control channel elements of a plurality of groups of control channel elements within the control resource set is to be punctured, wherein the group comprises the subset of control channel elements within the control resource set.

11. The UE of claim 1, wherein, to process the set of downlink control channel candidates, the one or more processors are individually or collectively operable to execute the code to cause the UE to:
process each control channel element of a first downlink control channel candidate, wherein one or more of the processed control channel elements of the first downlink control channel candidate are punctured in accordance with the information received via the control signaling.

12. The UE of claim 11, wherein, to process the one or more control channel elements that are punctured within the first downlink control channel candidate, the one or more processors are individually or collectively operable to execute the code to cause the UE to:
mute the one or more control channel candidates that are punctured within the first downlink control channel candidate.

13. The UE of claim 1, wherein, to process the set of downlink control channel candidates, the one or more processors are individually or collectively operable to execute the code to cause the UE to:
process a subset of control channel elements of a first downlink control channel candidate, wherein the subset excludes one or more control channel elements of the first downlink control channel candidate that are punctured in accordance with the information received via the control signaling.

14. The UE of claim 1, wherein the one or more processors are individually or collectively further operable to execute the code to cause the UE to:
perform a set of control channel estimates using control channel elements within the control resource set based at least in part on the information that indicates that each control channel element of the subset of control channel elements is to be punctured.

15. The UE of claim 1, wherein the one or more processors are individually or collectively further operable to execute the code to cause the UE to:
count a quantity of blind decodes based at least in part on the information that indicates that each control channel element of the subset of control channel elements is to be punctured.

16. The UE of claim 1, wherein the subset of control channel elements of the control resource set comprises one or more contiguous control channel elements of the control resource set, one or more non-contiguous control channel elements in the control resource set, or both the one or more contiguous control channel elements and the one or more non-contiguous control channel elements.

17. A network entity, comprising:
one or more memories storing processor-executable code; and
one or more processors coupled with the one or more memories and individually or collectively operable to execute the code to cause the network entity to:
output control signaling comprising information that indicates that each control channel element of a subset of control channel elements within a control resource set is to be punctured; and
output, via the control resource set, a downlink control channel message based at least in part on puncturing each control channel element of the subset of control channel elements within the control resource set.

18. The network entity of claim 17, wherein, to output the control signaling, the one or more processors are individually or collectively operable to execute the code to cause the network entity to:
output one or more radio resource control (RRC) messages comprising the information that indicates that each control channel element of the subset of control channel elements is to be punctured.

19. The network entity of claim 17, wherein, to output the control signaling, the one or more processors are individually or collectively operable to execute the code to cause the network entity to:
output a medium access control (MAC)-control element (CE) activation command, wherein the MAC-CE activation command activates a state that indicates that each control channel element of the subset of control channel elements is to be punctured.

20. The network entity of claim 17, wherein, to output the control signaling, the one or more processors are individually or collectively operable to execute the code to cause the network entity to:
output one or more downlink control information (DCI) messages comprising one or more DCI fields, wherein the one or more DCI fields comprise the information that indicates that each control channel element of the subset of control channel elements is to be punctured.

21. The network entity of claim 20, wherein:
the one or more DCI messages are associated with a DCI format, and
the DCI format comprises the one or more DCI fields including a set of indexes indicative of the subset of control channel elements to be punctured, one or more first indications of respective positions of first control channel elements of the subset of control channel elements and respective quantities of contiguous control channel elements punctured, one or more second indications of respective entries in a table, or any combination thereof.

22. The network entity of claim 17, wherein, to output the control signaling, the one or more processors are individually or collectively operable to execute the code to cause the network entity to:
output a first downlink control information (DCI) message comprising an identifier of the control resource set and the information that indicates that each control channel element of the subset of control channel elements within the control resource set is to be punctured, and wherein outputting the downlink control channel message comprises:
output a second DCI message comprising a downlink grant associated with a user equipment (UE) or a group of UEs, wherein a downlink control channel carrying the second DCI message is punctured in accordance with the information of the first DCI message.

23. The network entity of claim 17, wherein the one or more processors are individually or collectively further operable to execute the code to cause the network entity to:
rate match each control channel element of a first downlink control channel candidate, wherein one or more of the rate matched control channel elements of the first downlink control channel candidate are punctured in accordance with the information output via the control signaling, and wherein outputting the downlink control channel message is based at least in part on the rate matching.

24. The network entity of claim 17, wherein the one or more processors are individually or collectively further operable to execute the code to cause the network entity to:
rate match a subset of control channel elements of a first downlink control channel candidate, wherein the subset of control channel elements of the first downlink control channel candidate excludes one or more control channel elements of the first downlink control channel candidate that are punctured in accordance with the information output via the control signaling, and wherein outputting the downlink control channel message is based at least in part on the rate matching.

25. The network entity of claim 17, wherein the one or more processors are individually or collectively further operable to execute the code to cause the network entity to:
obtain a capability message associated with puncturing of control channel elements, wherein outputting the control signaling comprising the information that indicates that each control channel element of the subset of control channel elements within the control resource set is to be punctured is based at least in part on the capability message.

26. The network entity of claim 25, wherein the capability message comprises an indication that a user equipment (UE) supports rate-matching over aggregation levels associated with different powers of two or that the UE supports rate-matching over aggregation levels different from the aggregation levels associated with different powers of two.

27. A method for wireless communications at a user equipment (UE), comprising:
receiving control signaling comprising information that indicates that each control channel element of a subset of control channel elements within a control resource set is to be punctured;
processing, based least in part on the information that indicates that each control channel element of the subset is to be punctured, a set of downlink control channel candidates within the control resource set; and
decoding a downlink control channel message based at least in part on processing the set of downlink control channel candidates.

28. The method of claim 27, further comprising:
transmitting a capability message associated with puncturing of control channel elements, wherein receiving the control signaling comprising the information that indicates that each control channel element of the subset of control channel elements within the control resource set is to be punctured is based at least in part on the capability message.

29. The method of claim 28, wherein the capability message comprises an indication that the UE supports rate-matching over aggregation levels associated with different powers of two or that the UE supports rate-matching over aggregation levels different from the aggregation levels associated with different powers of two.

30. A method for wireless communications at a network entity, comprising:
outputting control signaling comprising information that indicates that each control channel element of a subset of control channel elements within a control resource set is to be punctured; and
outputting, via the control resource set, a downlink control channel message based at least in part on puncturing each control channel element of the subset of control channel elements within the control resource set.
